(19) United States
(12) Patent Application Publication
(10) Pub. No.: US 2023/0334332 A1
(43) Pub. Date: Oct. 19, 2023

(54) DETECTING ADVERSARIAL EXAMPLES USING LATENT NEIGHBORHOOD GRAPHS

(71) Applicant: Visa International Service Association, San Francisco, CA (US)

(72) Inventors: Yuhang Wu, San Francisco, CA (US); Sunpreet Singh Arora, San Jose, CA (US); Hao Yang, San Jose, CA (US); Ahmed Abusnaina, San Francisco, CA (US)

(73) Assignee: Visa International Service Association, San Francisco, CA (US)

(21) Appl. No.: 18/028,845

(22) PCT Filed: Sep. 30, 2021
(86) PCT No.: PCT/US2021/052798

§ 371 Date: Mar. 28, 2023

Related U.S. Application Data
(60) Provisional application No. 63/088,371, filed on Oct. 6, 2020.

(51) Int. Cl. G06N 3/094

(52) U.S. Cl. CPC G06N 3/094

(57) ABSTRACT

Techniques are disclosed for performing adversarial object detection. In one example, a system obtains a feature vector upon receiving an object to be classified. The system then generates a graph using the feature vector for the object and other feature vectors that are respectively obtained from a reference set of objects, whereby the feature vector corresponds to a center node of the graph. The system uses a distance metric to select neighbor nodes from among the reference set of objects for inclusion into the graph, and then determines edge weights between nodes of the graph based on a distance between respective feature vectors between nodes. The system then applies a graph discriminator to the graph to classify the object as adversarial or benign, the graph discriminator being trained using (I) the feature vectors associated with nodes of the graph and (II) the edge weights between the nodes of the graph.

### CROSS-REFERENCE TO RELATED APPLICATIONS

This international application claims priority to U.S. Provisional Patent Application No. 63/088,371, filed on Oct. 6, 2020, the disclosure of which is herein incorporated by reference in its entirety for all purposes.

### BACKGROUND

Machine and deep learning techniques are used, particularly in image classification and authentication systems. However, unauthorized users (e.g., an attacker) may be able to use one or more methods to generate a particularly crafted input, such that, when input into the model, the attacker may manipulate the model to output a desired output of the attacker. As such, there is a need for better detection of adversarial inputs that may otherwise cause incorrect classifications.

Embodiments of the present disclosure address these and other problems, individually and collectively.

### BRIEF SUMMARY

Embodiments of the disclosure provide systems, methods, and apparatuses for using machine learning to improve accuracy when classifying objects. For example, a system may receive sample data of an object to be classified (e.g., pixel data of an image of a first person's face). The system may be tasked with determining, among other things, whether the received image is benign (e.g., an unperturbed image of the first person's face) or adversarial. In this example, an adversarial image may correspond to a modified image that perturbs the original image (e.g., changes some pixels of the image by adding noise) in such a way that, although the adversarial image may look similar to (e.g., the same as) the original received image (e.g., from a human eye perspective), the adversarial image may be classified differently by a pre-trained classifier (e.g., utilizing a machine learning model, such as a neural network). For example, the pre-trained classifier may incorrectly classify the image as showing a second person's face instead of the first person's face.

Accordingly, the system may perform techniques to mitigate the risk of misclassification of the image by the pre-trained classifier (e.g., to improve overall classification accuracy). For example, the system may generate a graph (e.g., which may be alternatively referred to herein as a latent neighborhood graph). The graph may represent, among other things, relationships (e.g., distances, feature similarities, etc.) between the object in question (e.g., the image to be classified) and other objects selected from a reference dataset of objects (e.g., including other labeled benign and adversarial images), each object corresponding to a particular node of the graph. In some embodiments, the graph may include an embedding matrix (e.g., including feature vectors for respective objects/nodes in the graph) and an adjacency matrix (e.g., including edge weights of edges between nodes of the graph). The system may then input the graph into a graph discriminator (e.g., which may included a neural network) that is trained to utilize the feature vectors and edge weights of the graph to output a classification of whether the received image is benign or adversarial.

According to one embodiment of the disclosure, a method for training a machine learning model to classify an object (e.g., a training sample) as adversarial or benign is provided. The method also includes storing a set of training samples that may include a first set of benign training samples and a second set of adversarial training samples, each training sample having a known classification from a plurality of classifications. The method also includes obtaining, with a pre-trained classification model, a feature vector for each training sample of the first set and the second set of training samples. The method also includes determining a graph for each training sample of the set of training samples, the respective training sample corresponding to a center node of a set of nodes of the graph, where determining the graph may include: selecting, using a distance metric associated with the center node of the graph, neighbor nodes around the center node and are to be included in the set of nodes of the graph, each neighbor node labeled as either a benign training sample or an adversarial training sample of the set of training samples; and determining an edge weight of an edge between a first node and a second node of the set of nodes of the graph based on a distance between respective feature vectors of the first node and the second node. The method also includes training, using each determined graph, a graph discriminator to differentiate between benign samples and adversarial samples, the training using (i) the feature vectors associated with nodes of the graph and (ii) the edge weights between the nodes of the graph.

According to another embodiment of the disclosure, a method of using a machine learning model to classify an object with a first classification (e.g., adversarial) or a second classification (e.g., benign) is provided. The method also includes receiving sample data of an object to be classified. The method also includes executing, using the sample data, a classification model to obtain a feature vector, the classification model trained to assign a classification of a plurality of classifications to the sample data, the plurality of classifications including a first classification and a second classification. The method also includes generating a graph using the feature vector and other feature vectors that are respectively obtained from a reference set of objects, the reference set of objects respectively labeled with the first classification or the second classification, the feature vector for the object corresponding to a center node of a set of nodes of the graph, where determining the graph may include: selecting, using a distance metric associated with the center node of the graph, neighbor nodes that neighbor the center node and are to be included in the set of nodes of the graph, each neighbor node corresponding to an object of the reference set of objects and having the first classification or the second classification; and determining an edge weight of an edge between a first node and a second node of the set of nodes of the graph based on a distance between respective feature vectors of the first node and the second node. The method also includes applying a graph discriminator to the graph to determine whether the sample data of the object is to be classified with the first classification or the second classification, the graph discriminator trained using (i) the feature vectors associated with nodes of the graph and (ii) the edge weights between the nodes of the graph.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 illustrates an example process for using a machine learning model to perform adversarial object (e.g., sample) detection, according to some embodiments;

FIG. 2 shows a flow diagram illustrating techniques for performing adversarial sample detection, according to some embodiments;

FIG. 3 illustrates adversarial examples of systems utilizing a machine learning model that may be adversely affected by perturbing the model's input feature space, according to some embodiments;

FIG. 4 illustrates another example of an adversarial effect on an output of a machine learning model based on perturbing the model's input feature space, according to some embodiments;

FIG. 5 illustrates another example of techniques that may be used to generate adversarial samples, according to some embodiments;

FIG. 6 illustrates an example of a dataset that may be used to train a machine learning model to perform adversarial image detection, according to some embodiments;

FIG. 7 illustrates another example process for performing adversarial object detection, according to some embodiments;

FIG. 8 illustrates an example technique that may be used to generate a graph that is subsequently used to perform adversarial object detection, according to some embodiments;

FIG. 9 illustrates another example technique that may be used to generate a graph that is subsequently used to perform adversarial object detection, according to some embodiments;

FIG. 10 illustrates a technique for optimizing a graph that is used to perform adversarial object detection, according to some embodiments;

FIG. 11 illustrates a graph discriminator that may be used to perform adversarial object detection, according to some embodiments;

FIG. 12 illustrates a flowchart for training a machine learning model of a system to perform adversarial object detection, according to some embodiments;

FIG. 13 illustrates a flowchart for using a machine learning model of a system to perform adversarial object detection, according to some embodiments;

FIG. 14 illustrates a performance comparison between a system described herein for performing adversarial object detection and other adversarial detection approaches; and

FIG. 15 illustrates a computer system that may be trained and/or utilized to perform adversarial sample detection, according to some embodiments.

### TERMS

Prior to discussing embodiments of the invention, description of some terms may be helpful in understanding embodiments of the invention.

A “user device” can include a device that is used by a user to obtain access to a resource. The user device may be a software object, a hardware object, or a physical object. As examples of physical objects, the user device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device (e.g., an identifier for a payment account). In a payment example, a user device may be a payment card (e.g., debit card, credit card). Other examples of user devices may include a mobile phone, a smart phone, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, text data, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G, or similar networks), Wi-Fi, Wi-Max, or any other communication medium that may provide access to a network such as the Internet or a private network.

A “user” may include an individual. In some embodiments, a user may be associated with one or more personal accounts and/or user devices. The user may also be referred to as a cardholder, account holder, or consumer in some embodiments.

A “credential” may include an identifier that is operable for verifying a characteristic associated with a user and/or a user account. In some embodiments, the credential may be operable for validating whether a user has authorization to access a resource (e.g., a merchandise goods, a building, a software application, a database, etc.). In some embodiments, the credential may include any suitable identifier, including, but not limited to, an account identifier, a user identifier, biometric data of the user (e.g., an image of the user's face, a voice recording of the user's voice, etc.), a password, etc.

An “application” may be a computer program that is used for a specific purpose. Examples of applications may include a banking application, digital wallet application, cloud services application, ticketing application, etc.

A “user identifier” may include any characters, numerals, or other identifiers associated with a user device of a user. For example, a user identifier may be a personal account number (PAN) that is issued to a user by an issuer (e.g., a bank) and printed on the user device (e.g., payment card) of the user. Other non-limiting examples of user identifiers may include a user email address, user ID, or any other suitable user identifying information. The user identifier may also be identifier for an account that is a substitute for an account identifier. For example, the user identifier could include a hash of a PAN. In another example, the user identifier may be a token such as a payment token.

A “resource provider” may include an entity that can provide a resource such as goods, services, information, and/or access. Examples of resource providers includes merchants, data providers, transit agencies, governmental entities, venue and dwelling operators, etc.

A “merchant” may include an entity that engages in transactions. A merchant can sell goods and/or services or provide access to goods and/or services.

A “resource” generally refers to any asset that may be used or consumed. For example, the resource may be an electronic resource (e.g., stored data, received data, a computer account, a network-based account, an email inbox), a physical resource (e.g., a tangible object, a building, a safe, or a physical location), or other electronic communications between computers (e.g., a communication signal corresponding to an account for performing a transaction).

A “machine learning model” may refer to any suitable computer-implemented technique for performing a specific task that relies on patterns and inferences. A machine learning model may be generated based at least in part on sample data (“training data”) that is used to determine patterns and inferences, upon which the model can then be used to make predictions or decisions based at least in part on new data. Some non-limiting examples of machine learning algorithms used to generate a machine learning model include supervised learning and unsupervised learning. Non-limiting examples of machine learning models include artificial neural networks, decision trees, Bayesian networks, natural language processing (NLP) models, etc.

An “embedding” may be a multi-dimensional representation (e.g., mapping) of an input to a position (e.g., a “context”) within a multi-dimensional contextual space. The input may be a discrete variable (e.g., a user identifier, a resource provider identifier, an image pixel data, text input, audio recording data), and the discrete variable may be projected (or “mapped”) to a vector of real numbers (e.g., a feature vector). In some cases, each real number of the vector may range from −1 to 1. In some cases, a neural network may be trained to generate an embedding. In some embodiments, the dimensional space of the embedding may collectively represent a context of the input within a vocabulary of other inputs. In some embodiments, an embedding may be used to find nearest neighbors (e.g., via a k-nearest neighbors algorithm) in the embedding space. In some embodiments, an embedding may be used as input to a machine learning model (e.g., for classifying an input). In some embodiments, embeddings may be used for any suitable purpose associated with similarities and/or differences between inputs. For example, distances (e.g., Euclidean distances, cosine distances) may be computed between embeddings to determine relationships (e.g., similarities, differences) between embeddings. In some embodiments, any suitable distance metric (e.g., algorithm and/or parameters) may be used to determine a distance between one or more embeddings. For example, a distance metric may correspond to parameters of a k-nearest neighbors algorithm (e.g., for particular values of k (e.g., a number of nearest neighbors located for a given node, per round), a number of rounds (n), etc.).

An “embedding matrix” may be a matrix (e.g., a table) of embeddings. In some cases, each column of the embedding table may represent a dimension of an embedding, and each row may represent a different embedding vector. In some cases, an embedding matrix may contain embeddings for any suitable number of respective input objects (e.g., images, etc.). For example, a graph of nodes may exist, whereby each node may be associated with an embedding for an object.

An “adjacency matrix” may be a matrix that represents relationships (e.g., connections/links) between nodes of a graph. In some embodiments, each data field of the matrix (e.g., a row/column pair) may include data associated with a link between two nodes of the graph. In some embodiments, the data correspond to any suitable value(s). For example, the data may correspond to an edge weight (e.g., a real number between 0-1). In some embodiments, the edge weight may indicate a relationship between the two nodes (e.g., a level of correlation between features of the given two nodes). In some embodiments, the edge weight may be determined using any suitable function. For example, one function may map the distance between two nodes (e.g., between two feature vectors (e.g., embeddings) of respective nodes) from a first space to a second space. In some embodiments, the mapping may correspond to a non-linear (or linear) mapping. In some embodiments, the function be expressed using one or more parameters that be used used to operate on the distance variable between two nodes. In some embodiments, some parameters of the function may be determined during a training process. In some embodiments, the edge weight may also (and/or alternatively) be expressed as a binary value (e.g., 0 or 1), for example, indicating whether an edge exists between any given two nodes of the graph. For example, using the illustration above, the edge weight (e.g., originally a real number between 0 and 1) may be transformed into 0 (e.g., indicating no edge) or 1 (e.g., indicating an edge) depending on a threshold value (e.g., a cut-off value, such as 0.5, 0.6, etc.). In this example, if the original edge weight is less than the threshold value, no edge may be created, whereas an edge may be created if the original edge weight is greater than or equal to the threshold value. It should be understood that any suitable representation and/or technique may be used to express relationships (e.g., connections) between nodes of the graph. For example, in another embodiments, data field values of the adjacency matrix may be determined using a k-nearest neighbor algorithm (e.g., whereby a value may be 1 if a node is determine to be a nearest neighbor of another node, and 0 if it is not).

A “latent neighborhood graph” (which may alternatively be described herein as a “graph” or “LNG”) may include one or more structures corresponding to a set of objects in which at least some pairs of the objects are related. In some embodiments, the objects of a latent neighborhood graph may be referred to as “nodes” or “vertices,” and each of the related pairs of vertices may be referred to as an “edge” (or “link”). In some embodiments, any suitable number (e.g., and/or combination) of edges between vertices may exist in the graph. In some embodiments, an object may correspond to any suitable type of data object (e.g., an image, a sequence of text, a video clip, etc.). In some embodiments, the data object (e.g., an embedding/feature vector) may represent one or more characteristics (e.g., features) of the object. In some embodiments, the data object may be determine using any suitable method (e.g., via a machine learning model, such as a classifier). In some embodiments, the set of data objects and/or links between objects may be represented via any suitable one or more data structures (e.g., one or more matrices, tables, nodes, etc.). For example, in some embodiments, the set of data objects may be represented by an embedding matrix (e.g., in a case where each node is of the graph is associated with a particular embedding). In some embodiments, links (e.g., edges and/or edge weights) between nodes of the graph may be represented by an adjacency matrix. In some embodiments, the latent neighborhood graph may be represented by both the embedding matrix and/or adjacency matrix. It should be understood that any suitable technique and/or algorithm may be used to determine the collection of nodes of the graph and/or edges (and/or edge weights) between nodes. For example, in some embodiments, the latent neighborhood graph may include a node (which may be referred to herein as a “center node”) of the set of nodes of the graph. In some embodiments, the center node is “central” to the graph in part because other nodes may be selected as for inclusion in the graph “neighbor nodes” (e.g., selected from a set of reference objects) based on the center node, operating as an initial node of the graph. For example, other nodes may be selected based on a distance metric, which may include determining a distance from the center node (e.g., utilizing a k-nearest neighbor algorithm). In another example, nodes may be included in the graph as neighbor nodes of the center node based on a selection by a machine learning model. In some embodiments, one or more techniques may be used (e.g., separately and/or in conjunction with each other) to determine the nodes of the graph. In another example, related to techniques for determining relationships between one or more pairs of nodes of the graph, an algorithm may be used to determine edge weights (e.g., associated with a level of similarity and/or distance) between nodes. For example, an algorithm may determine edge weights based on a distance (e.g., a Euclidean distance) between feature vectors associated with each node. In some embodiments, an edge weight may be further used to determine whether an edge exists or not (e.g., based on a threshold value). In some embodiments, links (e.g., relationships) between nodes may be expressed as weights (e.g., real number values) instead of a binary value (e.g., of 1 or 0). In some embodiments, any suitable parameters may be used to determine nodes and/or relationships between nodes of the graph. For example, one or more parameters may be used to select nodes (e.g., the value of k for a k-nearest neighbors algorithm). In another example, parameters of a function (e.g., an “edge estimation function”) that is used to determine edge weights may be determined via a training process (e.g., involving a machine learning model).

An “edge estimation function” may correspond to a function that determines edge values for node pairs of a graph (e.g., a latent neighborhood graph). In some embodiments, an edge value (e.g., an edge weight) may indicate a type of relationship (e.g., level of correlation) between a pair of nodes of the graph. For example, the edge estimation function may determine an edge weight based on a distance between nodes (e.g., a Euclidean distance, a cosine distance, etc.). In some embodiments, the edge estimation function may a map distance value, corresponding to a distance between two nodes of a graph, from a first space to a second space. For example, the function may include a non-linear (and/or non-linear) component that transforms the distance between nodes to a new value (corresponding to a new space). In some embodiments, an edge weight may be inversely correlated with a distance between corresponding feature vectors of two nodes (a pair of nodes). In some embodiments, the function may be monotonic with the distance between nodes. For example, an edge weight between nodes may monotonically decrease as the distance between nodes increases. In some embodiments, one or more parameters may be used to express the function. In some embodiments, the one or more parameters be determined during a training process, for example, as part of a process used to train a machine learning model (e.g., a machine learning model of a graph discriminator).

A “graph discriminator” may include an algorithm that determines a classification for an input. In some embodiments, the algorithm may include utilizing one or more machine learning models. In some embodiments, the one or more machine learning models may utilize a graph attention network architeture. It should be understood that any suitable one or more machine learning models may be used by the graph discriminator. For example, in one embodiments, the network architecture may include multiple (e.g., three, four, etc.) consecutive graph attention layers, followed by a dense layer with 512 neuron, and a dense classification layer with two-class output (e.g., adversarial or benign classification). In some embodiments, the graph discriminator may receive as input a graph data of a graph (e.g., an adjacency matrix and/or an embedding matrix). In some embodiments, the graph discriminator may be trained based on receiving multiple graphs as input, whereby a training iteration may be performed using a particular graph (e.g., an LNG) as training data. In some embodiments, the graph discriminator may be trained in conjunction with training for other parameters. For example, parameters for determining the function for edge weights of a graph may be determined in conjunction with training parameters of the graph discriminator. Upon being trained, the graph discriminator may output, for a given input (e.g., an input graph corresponding to a sample object), a classification for the object (e.g., indicating whether the object is benign (e.g., a first classification) or adversarial (e.g., a second classification). It should be understood that the graph discriminator may be trained to output any suitable types of classifications (e.g., high risk, moderate risk, low risk, etc.) for suitable input objects (e.g., images, text input, video frames, etc.).

A “processor” may include a device that processes something. In some embodiments, a process can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may include any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

The term “server computer” may include a powerful computer or cluster of computers. For example, the server computer can be a large mainframe, a minicomputer cluster, or a group of computers functioning as a unit. In one example, the server computer may be a database server coupled to a web server. The server computer may be coupled to a database and may include any hardware, software, other logic, or combination of the preceding for servicing the requests from one or more other computers. The term “computer system” may generally refer to a system including one or more server computers coupled to one or more databases.

As used herein, the term “providing” may include sending, transmitting, making available on a web page, for downloading, through an application, displaying or rendering, or any other suitable method.

Details of some embodiments of the present disclosure will now be described in greater detail.

### DETAILED DESCRIPTION

Machine and deep learning techniques are used, particularly in image classification and authentication systems. However, adversarial attacks on machine learning models may be leveraged to manipulate the output of the machine learning-based systems to the attacker's desired output, by applying a minimal crafted perturbation to the feature space. Such attacks may be considered as a drawback of using machine learning in critical systems, such as user authentication and security.

For example, consider the case of machine learning as applied to image recognition. A particular machine learning model may be trained to classify images into one or more classes (e.g., cat, dog, panda, etc.). An authorized user might slightly alter (e.g., peturb and/or add noise to) a particular image that shows a panda so that, although to a human eye, the image still appears to show a panda, the machine learning model will incorrectly classify the altered image as a gibbon.

In another example, involving a machine learning model that is trained to determine if a transaction request is fraudulent, an attacker may, over time, learn a feature space of the machine learning model. For example, the attacker may learn how the model processes certain transaction inputs (e.g., learn the feature space of the model) based in part on whether or not a series of transactions (e.g., smaller transactions) are approved or not. The attacker may then generate a fraudulent transaction input that minimally perturbs the feature space (e.g., adding a particularly crafted noise, which may also be referred to herein as entropy data), such that, instead of classifying the model as fraudulent, the model instead incorrectly approves the transaction. In this way, the attacker may trick the classification model.

Techniques described herein may improve machine learning model accuracy when classifying objects. In some embodiments, these techniques may be used in scenarios in which there is a risk that an original object (e.g., a benign object) may have been modified in such a way as to cause a (e.g., pre-trained) classification model to misclassify the modified object. This may be particularly applicable in cases where the modified object is an adversarial object that is intended to evade authentication protocols enforced by a system (e.g., to gain access to a resource, to perform a privileged task, etc.). For example, consider a case in which a system may receive (e.g., from a user device) sample data of an object to be classified (e.g., pixel data of an image of a first person's face, which may correspond to a user identifier type of credential). The system may be tasked with determining, among other things, whether the received image is benign (e.g., an authentic image of the first person's face) or adversarial. In this example, an adversarial image may correspond to a modified image that perturbs the original image (e.g., changes some pixels of the image) in such a way that, although the adversarial image may look similar to (e.g., the same as) the original image (e.g., from a human eye perspective), the adversarial image may be classified differently by a pre-trained classifier (e.g., utilizing a machine learning model, such as a neural network). For example, the pre-trained classifier may incorrectly classify the image as showing a second person's face instead of the first person's face.

Accordingly, in this example, the system may perform techniques to mitigate the risk of misclassification of the image by the pre-trained classifier (e.g., to improve overall classification accuracy). For example, the system may generate a latent neighborhood graph (e.g., which may be alternatively referred to herein as a graph). The graph may represent, among other things, relationships (e.g., distances, feature similarities, etc.) between the object in question (e.g., the image to be classified) and other objects selected from a reference set of objects (e.g., including other labeled benign and adversarial images) to be included within a set of objects of the graph. Each object of the set of objects of the graph may correspond to a particular node of the graph. In some embodiments, the graph may include an embedding matrix (e.g., including embeddings (e.g., feature vectors) for respective objects/nodes in the graph) and an adjacency matrix (e.g., including edge weights of edges between nodes of the graph).

In some embodiments, neighbor nodes of the graph (e.g., corresponding to feature vectors of the embedding matrix) may be selected for inclusion in the graph based on a distance metric. For example, the distance metric may be associated with a distance from a center node of the graph, whereby the center node corresponds to the input image (e.g., a feature vector of the input image) that is to be classified. In this example, neighbor nodes of the latent neighborhood graph may be selected (e.g., from the reference set of objects) for inclusion within the set of nodes of the graph based on the distance metric. For example, a k-nearest neighbor algorithm may be executed to determine nearest neighbors from the center node, whereby the nodes that are determined to be nearest neighbors are included within the set of nodes of the graph.

In some embodiments, values (e.g., edge weights) of the adjacency matrix (e.g., which may represent relationships between node pairings of the graph) may be determined based on a function (e.g., an edge estimation function) that maps a distance (e.g., a Euclidean distance) between two nodes (e.g., between two embeddings of a node pair) of the graph from one space to another space. In some embodiments, the function may be expressed such that the edge weight increases as the distance between two nodes decreases. In some embodiments, parameters of the edge estimation function may be determined (e.g., optimized) as part of a training process that trains a graph discriminator of the system to output whether the image is benign or adversarial. It should be understood that any suitable function (e.g., a linear function, a non-linear function, a multi-parameter function, etc.) may be used to determine edge weights of the adjacency matrix. In some embodiments, the edge weights of the adjacency matrix may be used (e.g., by the edge estimation function) to determine whether an edge exists (or does not exist) between two nodes (e.g., based on a threshold/cut-off value). For example, if an edge weight is less than the threshold, then no edge may exist. If the edge weight is greater than or equal to the threshold, then an edge may exist. In some embodiments, the adjacency matrix may (or may not) be updated to reflect a binary relationship between nodes (e.g., whether an edges exists or does not exist). In some embodiments, edges of may be expressed on a continuum (e.g., a real number between 0 and 1), reflected by the edge weights. It should be understood that, although techniques described herein primarily describe expressing relationships (e.g., edges, edge weights, etc.) between nodes of a graph via an adjacency matrix, any suitable mechanism may be used.

Continuing with the example above, the system may then input the graph (e.g., including the embedding matrix and the adjacency matrix) into the graph discriminator (e.g., which may included a neural network). The graph discriminator may be trained to utilize the feature vectors and edge weights of the graph to output a classification of whether the received image is benign or adversarial. In some embodiments, the graph discriminator may aggregate information from the center node and neighboring nodes (e.g., based on the feature vectors of the nodes and/or edge weights between the nodes) to determine the classification.

In some embodiments, the system may optionally perform one or more further operations to improve classification accuracy. For example, in some embodiments, the system may train a neural network to select a node for inclusion in the latent neighborhood graph. In one example, for a given node (e.g, the center node, or another node already included within the current graph based on the distance metric from the center node), the system may determine candidate nearest neighbors for the given node. This may include a first candidate nearest neighbor, selected from the set of reference objects that are labeled as benign. This may also include a second candidate nearest neighbor, selected from the set of reference objects that are labeled as adversarial. In this example, the neural network may be trained to select from one of the candidates for inclusion in the graph.

In some embodiments, objects that are determined by the system to be adversarial (and/or benign) may be used to augment the reference set of objects. In some embodiments, new reference objects may be added to the set of reference objects without necessitating re-training a machine learning model that is used to determine whether objects are adversarial or not. This may provide a more efficient mechanism for quickly adjusting to new threats (e.g., newly crafted adversarial objects). For example, the latent neighborhood graph, generated using the reference set of objects, may be constructed to incorporate information from newly added objects, which may then feed into the existing graph discriminator.

Embodiments of the present disclosure provide several technical advantages over conventional approaches to adversarial sample detection. For example, some conventional approaches have limitations, including, for example: 1) lacking transferability, whereby they fail to detect adversarial images created by different adversarial attacks that the approaches were not designed to detect, 2) being unable to detect adversarial images with low perturbation, or 3) being slow, and/or unsuitable for online systems. Embodiments of the present disclosure leverage graph-based techniques to design and implement an adversarial examples detection approach that not only uses the encoding of the queried sample (e.g., an image), but also its local neighborhood by generating a graph structure around the queried image, leveraging graph topology to distinguish between benign and adversarial images. Specifically, each query sample is represented as a central node in an ego-centric graph, connected with samples carefully selected from the training dataset. Graph-based classification techniques are then used to distinguish between benign and adversarial samples, even when low perturbation is applied to cause the misclassification.

In another example of a technical advantage, a system according to embodiments described herein detects adversarial examples generated by known and unknown adversarial attacks with high accuracy. In some embodiments, the system may utilize a generic graph-based adversarial detection mechanism that leverages nearest neighbors in the encoding space. The system may also utilize the graph topology to detect adversarial examples, thus achieving a higher overall accuracy (e.g., 96.90%) on known and unknown adversarial attacks with different perturbation rates. In some embodiments, the system may also leverage deep learning techniques and graph convolutional networks to enhance the performance (e.g., accuracy) of the system, incorporating a step-by-step deep learning-based node selection model to generate graphs representing the queried images. In yet another example, the training dataset (e.g., used to generate a graph) may also be updated to incorporate new adversarial examples, such that the existing (e.g., without necessitating retraining) machine learning model may utilize the updated training dataset to more accurately detect (e.g., with higher precision and/or recall) similar such adversarial examples in the future, thus improving system efficiency in adapting to new adversarial inputs.

In some embodiments, the system is effective in detecting adversarial examples with low perturbation and/or generated using different adversarial attacks. Increasing the robustness of machine learning against adversarial attacks allows the implementation of such techniques in critical fields, including user and transaction authentication and anomaly detection.

These and other embodiments of the disclosure are described in detail below. For example, other embodiments are directed to systems, devices, and computer readable media associated with methods described herein.

For clarity of illustration, embodiments described herein are primarily described in reference to detecting adversarial images. However, embodiments should not be construed to be so limiting. For example, techniques described herein may also be applied to detecting transaction fraud, authorization to access a resource, or other suitable applications. Furthermore, techniques described herein may be applicable to any suitable scenario in which a machine learning model is trained to more accurately detect input that may be produced by perturbing an original input source. A better understanding of the nature and advantages of embodiments of the present disclosure may be gained with reference to the following detailed description and the accompanying drawings.

### I. System and Process Overview

As described herein, detection of adversarial examples with high accuracy may be critical for the security of deployed deep neural network-based models. To enable better detection with high accuracy, techniques herein include performing a graph-based adversarial detection method that constructs a latent neighborhood graph (an LNG) around an input example to determine if the input example is adversarial. Given an input example, selected reference adversarial and benign examples (e.g., which may be represented as nodes of the graph) may be used to capture a local manifold (e.g., a local topological space) in the vicinity of the input example. In some embodiments, the LNG node connectivity parameters are optimized jointly with the parameters of a graph discriminator (e.g., a graph attention network that utilizes a neural network) in an end-to-end manner to determine the optimal graph topology for adversarial example detection. The graph attention network may then be used to determine if the LNG is derived from an adversarial or benign input example.

A. System Overview

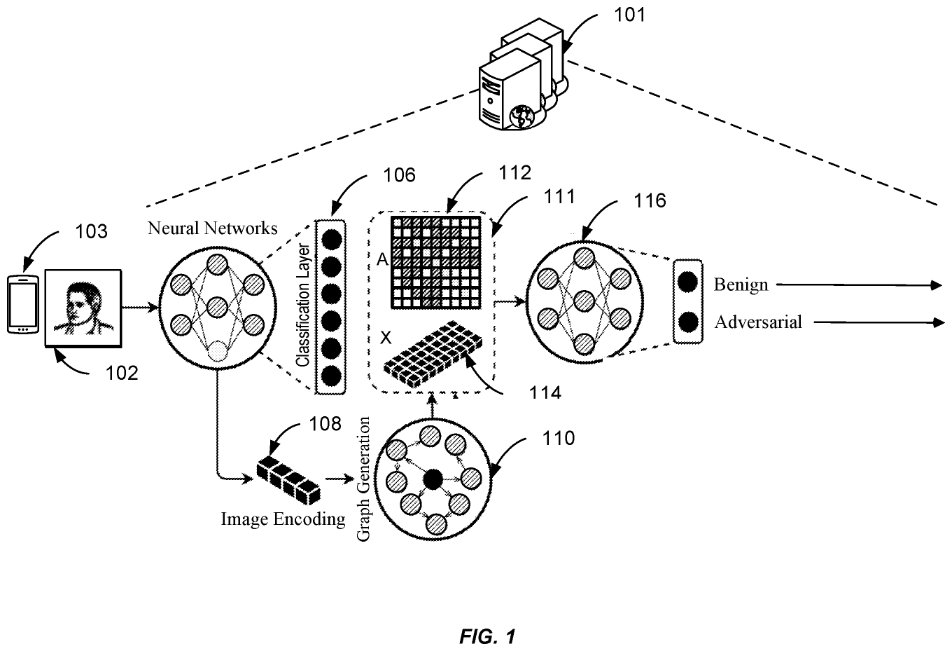

FIG. 1 shows a flow diagram illustrating components of a system 101 that performs adversarial sample detection, according to some embodiments. In some embodiments, the system 101 may include at least three components (e.g., modules), namely: 1) a pre-trained baseline classifier 104, 2) a graph generator 110 (e.g., for generating an LNG), 3) and a graph discriminator 116 (e.g., for outputting a classification of whether an input is benign or adversarial). In some embodiments, these components may execute other sub-modules (e.g., for training one or more machine learning models, computing weights, adding new data to a reference set, etc.). In the example illustration of FIG. 1, sample data 102 of an object (e.g., pixel data of an image) is received (e.g., from a user device 103) by the baseline classifier 104 (e.g., which may execute a pre-trained classification model, operating a neural network). A feature vector 108 (e.g., in this example, an image encoding, represented by an embedding) may be obtained by executing the baseline classifier 104. The graph generator 110 may use the feature vector 108 to generate a graph (e.g., a latent neighborhood graph), represented by graph representation 111. In this example, the graph representation 111 of the LNG may include an embedding matrix 114 (labeled “X” in FIG. 1) and an adjacency matrix 112 (labeled “A” in FIG. 1), described further herein. It should be understood that any suitable graph representation 111 may be used to represent the graph. Upon generating the graph representation 111, the system 101 may input the graph representation 111 into the graph discriminator 116, which may utilize a neural network (e.g., a graph attention network). The graph discriminator 116 may be trained to output whether the sample data 102 of the image is benign or adversarial.

It should be understood that any suitable computing device(s) (e.g., a server computer) may be used to perform the techniques executed by the system 101 described herein. In some embodiments, the sample data 102 may be correspondingly be received from any suitable computing device (e.g., another server computer, user device 103). For example, the system 101 may receive a plurality of training data samples from another server computer for use in training a machine learning model (e.g., the graph discriminator). In another example, the system 101 may receive input (e.g., a credential) from another user device (e.g., a mobile phone, a smartwatch, a laptop, PC, etc.), similar to (or different from) user device 103, for use in authenticating a transaction.

B. Process Overview

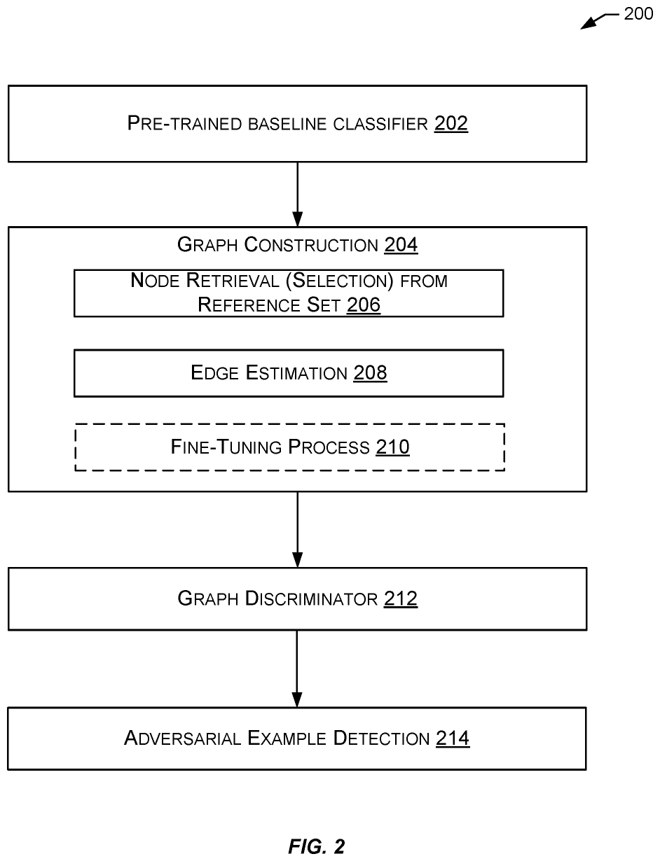

FIG. 2 shows the flow diagram whereby the different system components of FIG. 1 may operate to perform adversarial sample (e.g., image) detection.

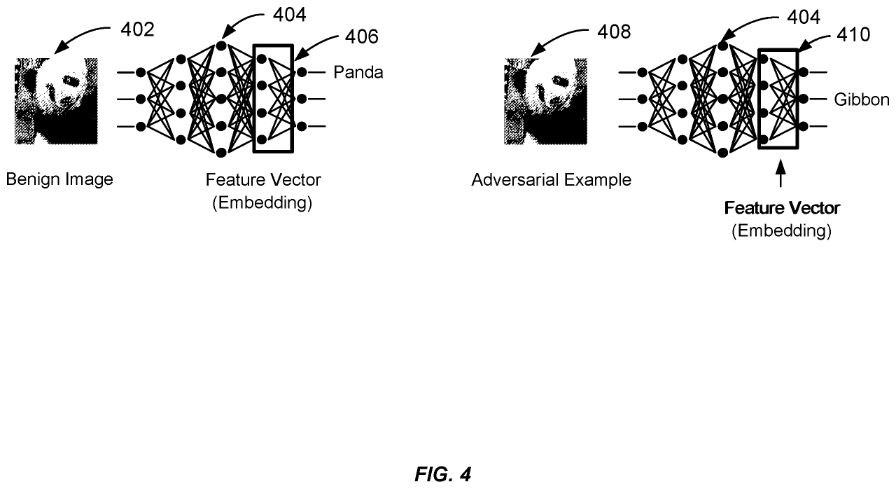

At block 202, a pre-trained baseline classifier (e.g., utilizing a pre-trained classification model) of the system receives sample data of an object to be classified. In some embodiments, any suitable machine learning model(s) may be used by the classifier (e.g., a neural network, such as a convolutional neural network (CNN)). In some embodiments, the system may operate on top of the baseline classifier, leveraging the encoding (e.g., feature vector/embedding) of each sample. For example, in some embodiments, the feature vector may be represented as the output of the last layer of the neural network (before the classification layer), as depicted and described below in reference to FIG. 4. In some embodiments, these extracted encodings are foundational to performing adverse sample detection. Accordingly, in some embodiments, the pre-trained baseline classifier may be trained to accurately distinguish between benign samples' different classes (e.g., plane, card, bird, cat, etc.) with high accuracy. In some embodiments, the baseline classifier (e.g., a ResNet classifier (such as ResNet-110 or ResNet-20), a Densenet classifier (such as Densenet-121), etc.) may be trained based on any suitable dataset (e.g., a CIFAR-10 dataset, ImageNet dataset, STL-10 dataset, etc.) and/or subset thereof. In some embodiments, at least a portion of the dataset may be stored as a set of reference objects (e.g., a set of samples forming a reference dataset) that may be used for generating an LNG, described further herein. In some embodiments, the set of reference objects may further include (and/or be augmented to include) adversarial objects that are generated by perturbing (e.g., adding noise to) the respectively corresponding original objects.

At block 204, a graph generator of the system performs graph construction of a graph (e.g., an LNG) based on the feature vector (associated with the sample data of the object to be classified) that is obtained from the baseline classifier. The graph generator may generate the graph based on executing a sequence of operations. In some embodiments, these operations may be performed by one or more sub-modules, described in further detail herein. For example, at block 206, a first module may select a subset of the set of reference objects for inclusion within the graph. In some embodiments, this subset of reference objects (e.g., represented by respective feature vectors obtained for each object) may be selected based on a distance metric (e.g., executing a k-nearest neighbor algorithm) from the center node (e.g., the feature vector for the object that is to be classified (received at block 202)). In some embodiments, feature vectors (e.g., embeddings) for the set of nodes may be stored in an embedding matrix, as described herein.

Upon selecting the set of nodes (e.g., including the center node and neighbor nodes) for the graph, at block 208, a second module of the graph generator may perform edge estimation for node pairs of the graph. In some embodiments, the edge estimation may determine edge weights for edges between node pairs. In some embodiments, the edge weights may be further quantized according to a threshold value (e.g., representing if an edge exists or does not exist between a node pair). In some embodiments, the edge weights and/or edges may be stored within an adjacency matrix, as described herein. In some embodiments, the graph may be represented by both the embedding matrix and the adjacency matrix.

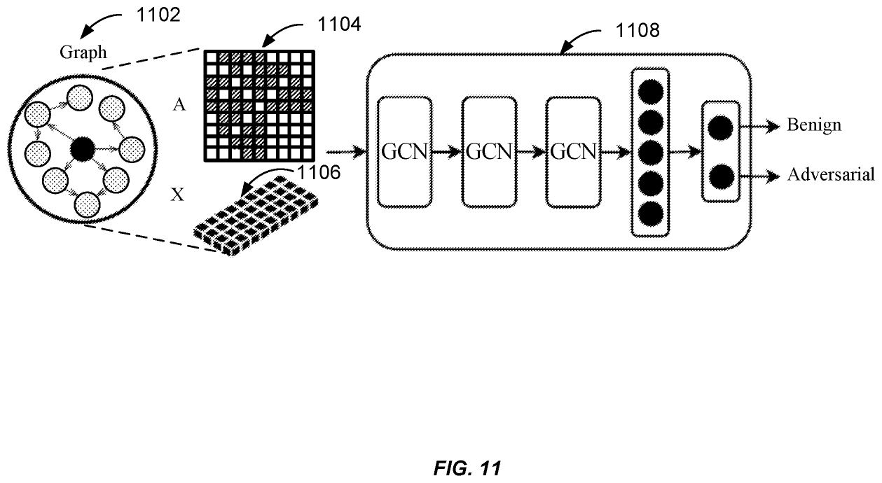

In some embodiments, the system may perform one or more other operations for further optimizing the process of graph construction. For example, at block 210, the graph generator may optionally perform a fine-tuning process. In one example of fine-tuning, related to node selection for the graph (described further herein in reference to FIG. 11), the graph generator may utilize a neural network to select nodes of the graph. In some embodiments, for a given node of the graph, the neural network may be trained to select from one of two candidate nodes (e.g., a nearest benign object or a nearest adversarial object). In some embodiments, the fine-tuning process of block 210 may be performed in conjunction with (and/or separately from) any one or more of the operations of block 206 or 208. For example, a set of candidate nodes may be selected at block 206, whereby a subset of the candidate nodes are selected for final inclusion within the graph based on the fine-tuning process of block 210.

At block 212, a graph discriminator of the system may use the graph (and/or aggregation data obtained from the graph) to perform adversarial sample detection of the object in question. In some embodiments, the graph discriminator utilize a graph attention network (GAN) architecture (e.g., including a neural network). In some embodiments, the neural network may be trained based on a plurality of graph inputs. For example, each graph of the plurality of graphs may be generated based on a particular training sample (e.g., corresponding to a center node of the respective graph) of the reference dataset (and/or any suitable training samples). In some embodiments, the graph discriminator may receive the graph (e.g., the adjacency matrix and embedding matrix) as input, aggregate information associated with the center node of the graph and its neighbors in the graph, and then use the aggregated information (e.g., a combined feature vector) as input to the GAN that determines a classification for the object (e.g., adversarial or benign). In some embodiments, the aggregation of information of the graph (e.g., based on the graph matrices) may be performed separately from the graph discriminator (e.g., by another process), whereby the graph discriminator receives the aggregated information and then outputs the classification.

In any case, at block 214, the graph discriminator may perform adversarial object detection based on the graph and the trained neural network. In some embodiments, the training process for training the graph discriminator may include determining one or more parameters. For example, the parameters may include parameters for a function (e.g., an edge estimation function) that is used to determine edge weights (and/or edges) for the graph. In another example, the parameters may include determining a suitable value for k (e.g., for executing a k-nearest neighbors algorithm), a number of layers in the GAN, and/or any suitable parameters.

In some embodiments, the resulting classification (e.g., benign or adversarial) may be used for any suitable purpose. For example, the system may use the classification to determine whether to authorize or deny a transaction (e.g., requesting access to a resource). In another example, the system may add the object to the reference data set, for future use in generating a graph. For example, if the system detects that the object is an adversarial object, whereby the pre-trained classifier had detected the object to be benign, the system may infer a new type of adversarial algorithm has been created, and use this technique to mitigate future attacks using that algorithm (e.g., to perturb the sample in a particular way).

### II. Generating Embeddings for Objects Using a Baseline Classifier

As described herein, in some embodiments, an object may be either benign or adversarial. An adversarial object may be generated from a benign object based on perturbing one or more characteristics (e.g., pixels of an image object) of the object. For a given object of any type (e.g., benign or adversarial), techniques herein may obtain a feature representation of the object. The feature representation may correspond to a feature vector (e.g., an embedding). This feature vector may be used as input to generate an LNG that is subsequently used to determine classification for the object.

A. Generating Adversarial Objects Using Benign Objects

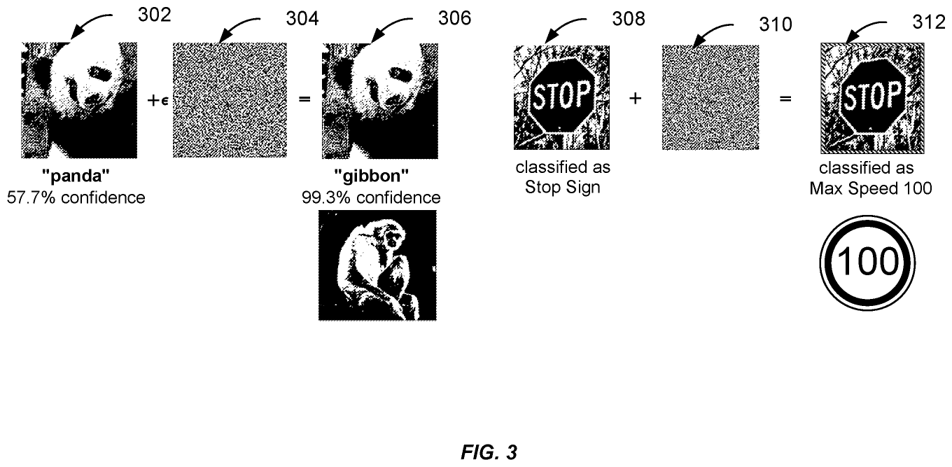

FIG. 3 illustrates adversarial examples of systems utilizing a machine learning model that may be adversely affected by perturbing the model's input feature space, according to some embodiments. In FIG. 1, two illustrations are depicted, which illustrate limitations of existing machine learning models. For example, in a first illustration, an first image 302 of a “panda” is shown. The first image 302 may be represented by a plurality of arranged pixels. In this first illustration, a user (e.g., an attacker) may determine a perturbation 304 (e.g., entropy data, such as noise) by which to modify the image to generate a second image 306 (e.g., an adversarial image). Note that the second image 306 may still look to the human eye like a panda. However, because the noise was generated and applied to modify the first image 302 in the particular way (e.g., a particularly crafted perturbation 304), the machine learning model (e.g., a pre-trained classifier) may incorrectly classify the second image 306 as a “gibbon” with high (e.g., 99.3%) confidence. The second illustration is illustrates a similar concept. A third image 308 showing a stop sign may be slightly modified via added noise 310 to generate a fourth image 312, that still appears (e.g., to the human eye) to be showing a stop sign. However, a trained model may recognize the new image (the fourth image 312) as a sign indicating a maximum speed of 100 miles per hour. These occurrences may cause an undesirable outcome in the real world if the model misclassifies input samples in this way. It should be understood that any suitable object data (e.g., a user identifier, such as an image, a voice recording, a video sample, a text sample, etc.) may be perturbed to generate a different (e.g., adversarial) output that may be otherwise misclassified by a pre-trained classifier.

B. Generating Embeddings for Objects

FIG. 4 illustrates another example of an adversarial effect on an output of a machine learning model based on perturbing the model's input feature space, according to some embodiments. As depicted in FIG. 3, a normal (e.g., also referred to as “benign”) image 402 may show a panda. A machine learning model 404 (e.g., a multilayered neural network) may be trained to generate an encoding (e.g., a feature vector 406 (e.g., an embedding) for the image), which may be subsequently used to generate a final one or more classifications for the image. In the example with the benign image 402, an encoding (e.g., represented, in this case, by the second to the last layer on the right, before the final classification layer) may be generated for the panda. However, as described with respect to FIG. 3, an adversarial image 408 may be created by perturbing features of the benign image 402 (e.g., pixels of the image), whereby the machine learning model may generate a different encoding for the adversarial image 408. As depicted in FIG. 4, the adversarial image 408 may be used as input to the machine learning model 404 to generate a feature vector 410 for the adversarial image 408. In some embodiments, the amount of difference between the two feature vectors may be variable (e.g., slight or significant, depending on the perturbation). In some embodiments, there is a possibility that the machine learning model 404 (e.g., a pre-trained neural network) may classify the adversarial image 408 (e.g., based on the respective feature vector 410) with a different classification from benign image 402 (e.g., associated with feature vector 406), even though the two images (and/or feature vectors) may appear similar. Although the examples depicted in FIG. 4 illustrate the feature vector as being derived from the second to last layer of nodes of the classifier, it should be understood that an feature vector (e.g., embedding) described herein may be generated from any suitable features (e.g., nodes, layers) of a machine learning model. It should be understood that embodiments described herein may not directly depend on the data classified. For example, in some embodiments, only the encoding provided by the baseline classifier may be utilized. Also, the encoding and/or input sample may not be restricted to a specific data format or shape.

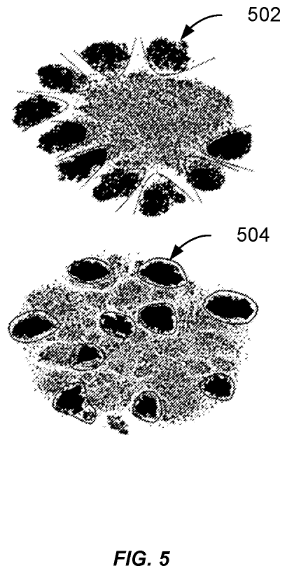

FIG. 5 illustrates another example of techniques that may be used to generate adversarial samples, according to some embodiments. In FIG. 5, two different and non-limiting example adversarial sample generation methods are illustrated for perturbing a dataset. The first method corresponds to a Fast Gradient Signed Method (FGSM), and the second method corresponds to a Carlini and Wagner (C&W) L2 approach. As illustrated by the diagrams in FIG. 5, each method may be used to determine what are regions (e.g., clusters) in which a machine learning model may classify data. In this way, the method may thereby determine areas outside the cluster in which to generate adversarial samples. For example, in the FGSM method, benign samples are represented by clusters 502 around the edges of an inner set of adversarial samples. Accordingly, the FGSM method may be used to generate an adversarial sample from a benign sample. Similarly, the C&W method also may enable adversarial samples to be generated from benign samples. For example, the lower diagram of FIG. 5 shows that benign sample clusters 504 are dotted among adversarial samples. Thus, both the FGSM and C&W methods enable a perturbation of a training dataset, to generate adversarial samples for further training of models described in embodiments herein. In some embodiments, the adversarial examples may be generated based on samples from any suitable dataset (e.g., CIFAR-10 dataset).

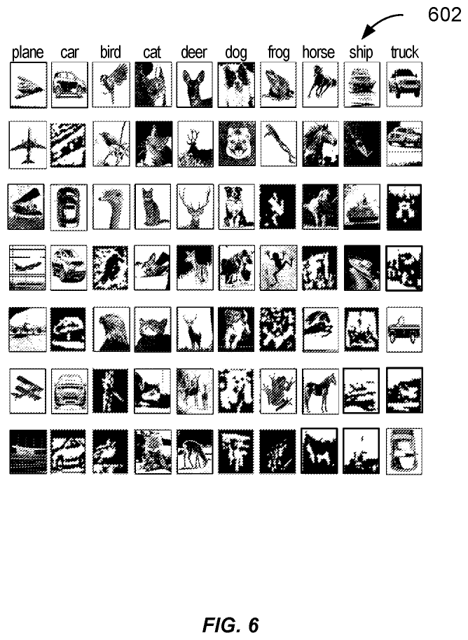

FIG. 6 illustrates an example of a reference dataset 602 that may be used to generate an adversarial examples dataset. The two datasets together may be used to train a machine learning model (e.g., a graph discriminator) to perform adversarial image detection, according to some embodiments. For example, as depicted in FIG. 6, different classes (e.g., plane, car, bird, etc.) are depicted, in which a set of training images exist for each class. In some embodiments, the reference dataset 602 may be generated based on any suitable dataset (e.g., the CIFAR-10 dataset, the ImageNet dataset, the STL-10 dataset, etc.) An adversarial samples reference dataset may be created by perturbing the reference dataset 602 (e.g., using the C&W L2 adversarial attack). Accordingly, an augmented reference dataset may include both a benign samples dataset and an adversarial samples dataset.

Following the creation of the augmented reference dataset, and, using the baseline classifier, the encoding (e.g., embedding) of each queried image for objects of the datasets may be obtained (as described herein). Accordingly, when generating graphs to be used for training a graph discriminator, a graph may (or may not) include both benign and adversarial samples. The generated graphs may vary as the encoding of the original and perturbed images may vary. The graph patterns (e.g., topology and subgraphs) may be used to detect adversarial examples. It should be understood that, although as described herein, training may be performed using an augmented dataset (e.g., including both types of samples), in some embodiments, a graph that is used for training may be constructed using only samples from a benign (or adversarial) training set. It should be understood that various datasets may be utilized perform techniques described herein. For example, a larger dataset (e.g., CIFAR-10, etc.) may be divided into subsets. One subset (e.g., a training subset) may be used for training a baseline classifier. As described above, a reference subset (and/or augmented subset) may be used for training a graph discriminator. Yet another subset (e.g., a testing subset) may be used for testing the trained graph discriminator.

### III. Graph Construction and Use for Training Graph Discriminator

In some embodiments, techniques herein include first generating an LNG for an input example, and then a graph discriminator (e.g., using a graph neural network (GNN)) exploits the relationship between nodes in the neighborhood graph to distinguish between benign and adversarial examples. In some embodiments, the system may thus harness rich information in local manifolds with the LNG, and use the GNNs model—with its high expressiveness—to effectively find higher-order patterns for adversarial example detection from the local manifolds of the nodes encoded in the graph.

A. Process Overview

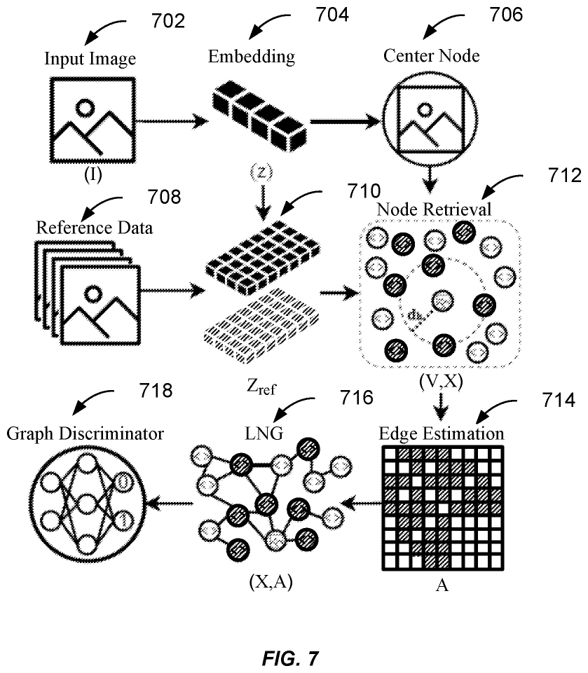

FIG. 7 illustrates an overview of a process for performing adversarial object detection via graph construction and using a graph discriminator, according to some embodiments. In FIG. 7, an image object is used as a representative example input. First, at block 702, the system may receive an input image. At block 704, for the given image I in the data set, the system may extract its embedding z from the pre-trained neural network model (e.g., the classifier being defended). At block 706, the system may use the embedding representation thereafter instead of the original pixel values, whereby the embedding representation corresponds to a center node of an LNG to be constructed. At block 708, in addition to the training data for the original learning task, the system may maintain an additional reference data set for retrieving the manifold information. At block 710 a set of embeddings may be generated, which may include the center node embedding, and then other embeddings obtained from the reference data set. At block 712, a neighborhood of n reference examples (e.g., neighbor nodes) is selected around z from the reference set. After retrieving the reference examples, the system may construct the following two matrices: (1) the n×m embedding matrix X may store the embeddings of neighborhood examples, where each row is a 1×m embedding vector of one example; the n×n adjacency matrix A may encode the manifold relation between pairs of examples in the neighborhood. At block 714, values (e.g., edge estimation values) for the adjacency matrix may be determined based on an efficient algorithm to estimate A based on the embedding distance between nodes. Accordingly, at block 716, the LNG of z may be characterized by these two matrices. Finally, at block 718, a graph discriminator (e.g., executing a GNN model) may receive both X and A as inputs, and predict whether z is an adversarial example. In some embodiments, as described further herein, the LNG node connectivity parameters may be optimized jointly with parameters of the graph discriminator (e.g., during training of the graph discriminator) in an end-to-end manner to determine the optimal graph topology for adversarial sample detection.

As described herein, and in further detail below, a latent neighborhood graph may be represented in any suitable data format (e.g., using one or more matrices). In some embodiments, a latent neighborhood graph may be characterized by an embedding matrix X and an adjacency matrix A. The system may construct an LNG by a 2-step procedure—node retrieval/selection (e.g., see block 712 of FIG. 7) followed by edge estimation (e.g., see block 714 of FIG. 7). The node retrieval process selects a set of points V in z's neighborhood from the reference data set. Stacking the embedding vectors of these points (including z) may yield the embedding matrix X, as described in reference to FIG. 7. Edge estimation may use a data-driven approach to determine the relationships between nodes in V, which yields the adjacency matrix A.

B. Latent Neighborhood Graph Construction

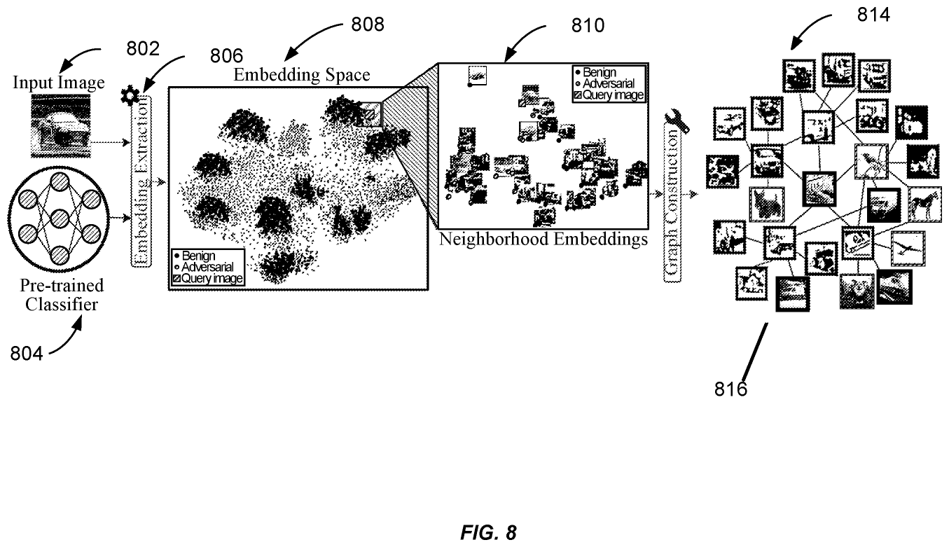

FIG. 8 depicts generation of a latent neighborhood graph for adversarial example detection. In some embodiments, after computing the input sample embedding, an LNG that describes the local manifold around the input example is constructed using both adversarial and benign example embeddings from a reference database (e.g., whereby reference examples are labeled accordingly). Subsequently, the LNG is then classified using a graph discriminator to determine whether the graph is generated from an adversarial or benign example.

In FIG. 8, an input image 802 is depicted as being received by the system. A pre-trained classifier 804 is used by the system to extract an embedding 806 of the input image 802. The embedding 806 may be included within an embedding space 808. In some embodiments, the embedding space 808 may be represent the topological relationships between a plurality of embeddings obtained from the reference database. In some embodiments, the reference database may correspond to any subset (e.g., some or all) of any suitable dataset (e.g., the CIFAR-10 dataset, STL-10 dataset, ImageNet dataset, etc.). Then, in a first step to generate the LNG, a subset of the embeddings of the embedding space 808 may be selected as neighbor nodes 810 (e.g., or “neighborhood embeddings”) of the embedding 806 (e.g., the center node), which may be similar to block 712 of FIG. 7. Following the selection (e.g., retrieval) of nodes, the graph construction may proceed whereby the system determines edges (e.g., and/or edge weights) between node pairings of the set of nodes via edge estimation. The final graph may be represented topologically (e.g., depicting links between images corresponding to the selected nodes/embeddings) by LNG 814 of FIG. 1. In this example, nodes with a black border box may be representative of benign images, while non-black (e.g., red) border boxes may be adversarial. Node 816 represents the center node of the LNG 814. It should be understood that, depending on whether the input sample (e.g., the center node) is in fact benign or adversarial, the topology and/or composition of the LNG 814 may differ. For example, in some embodiments, a benign image as the center node may have a higher likelihood of being more uniformly connected with other benign nodes. In some embodiments, an adversarial image as the center node may cause the graph to be less uniform (e.g., containing more heterogeneity among nodes of the graph, such as including a variety of both adversarial and benign nodes).

1. Node Retrieval

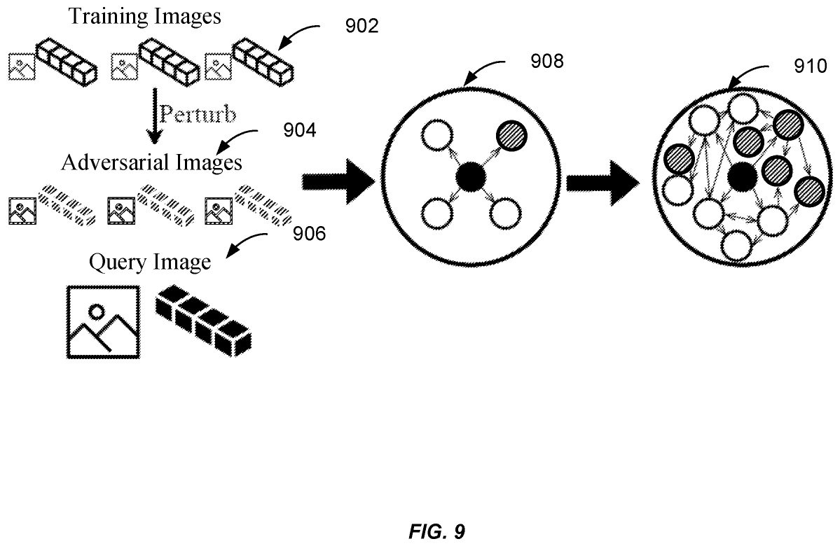

FIG. 9 illustrates a process for performing node selection (e.g., retrieval from the reference dataset) when generating an LNG. As depicted in FIG. 9 and described herein, the process may begin by generating a reference dataset for generating the LNG. In some embodiments, the reference dataset may be any suitable dataset (e.g., a subset of the CIFAR-10, STL-10, and/or ImageNet datasets). For example, in some embodiments, given a training set of inputs Z, the system may randomly sample a subset of inputs Z_{ref} as the reference dataset. The Z_{ref} may alternatively be referred to as the clean reference set 902 because the inputs are all natural. Given a trained model for the original task, an adversarially-augmented reference set may be generated. For example, the system may select an attack algorithm, create adversarial examples 904 for all inputs in Z_{ref} against the given model, and add the adversarial examples to Z_{ref}. In this example, the resulting adversarially-augmented reference set (e.g., including both the clean reference set 902 and the adversarial examples 904) will have twice as many points as the clean reference set. In some embodiments, these adversarial samples are able to encode information regarding the layout of adversarial examples to benign examples in the local manifold. In FIG. 9, the embedding 906 for the query image (z) corresponds to the object that is to be classified based on generating the LNG, which further corresponds to the center node of the LNG.

In some embodiments, the construction of V (e.g., corresponding to the set of nodes of the graph) starts with the generating a k-nearest-neighbor graph (k-NNG) of the input z and the nodes in Z_{ref} each point in Z_{ref}∪{z} is a node in the graph, and an edge from node i to node j exists iff j is among i's top-k nearest neighbors in distance (e.g., Euclidean distance) over the embedding space. In some embodiments, the system then keeps the nodes whose graph distance from z in the kNNG is within a threshold l. For example, if l=1, then the system may only keep the immediate top-k nearest neighbors of z (one-hop neighbors); if l=2, then the system may also keep the k nearest neighbors for each z's one-hop neighbors. As depicted in graph iteration 908 of FIG. 9 (e.g., a first iteration, in which l=1 and k=4), four nodes are selected as nearest neighbors of z (e.g., the center node). In this case, three nodes are benign (e.g., white nodes), and one node is adversarial (e.g., a red node). In a second graph iteration 910, in which l=2, the k nearest neighbors for each of z's one-hop neighbors are determined. Similar to the first iteration, a combination of benign or adversarial objects may be selected in the second iteration. It should be understood that the system may utilize any suitable values for l and k (e.g., I=1, 2, 4, etc.; k=40, 200, etc.), which may correspond to parameters of a distance metric associated with determining nearest neighbors.

Finally, the system may form V with n neighbors to z. Based on this breadth-first-search strategy to construct V, the node retrieval method may discover all nodes with a fixed graph distance to z, repeat the same procedure with increased graph distance until the maximum graph distance/is reached, and then return the n neighbors to z from the discovered nodes. The resulting. As described herein (e.g., see block 712 of FIG. 7), the embedding matrix X may include embeddings for each of the nodes of the set of nodes (V) of the graph.

2. Optimization (Fine-Tuning) for Node Selection

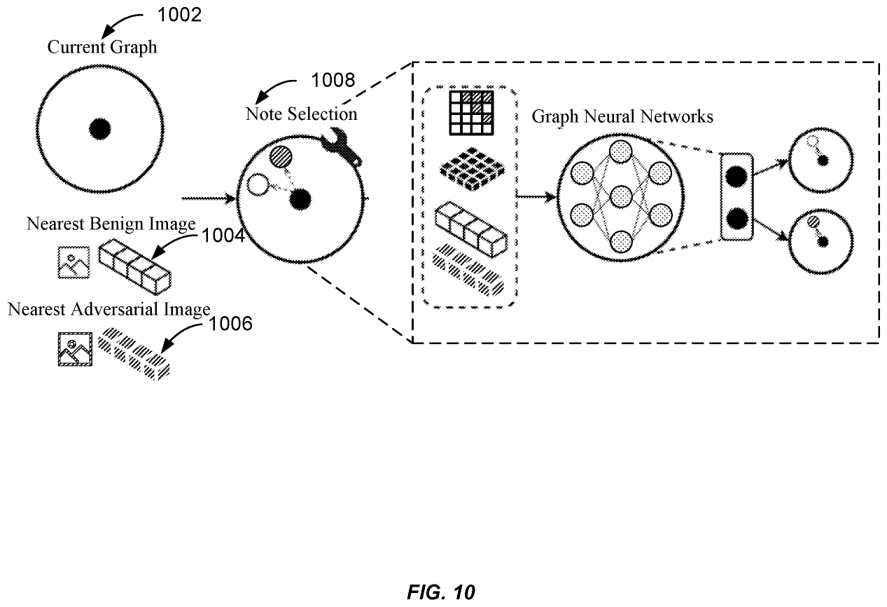

FIG. 10 illustrates a technique for optimizing (e.g., fine-tuning) the graph construction process. In some embodiments, the technique depicted in FIG. 10 may correspond an example of the fine-tuning process of block 210 of FIG. 2. In some embodiments, this process may be optionally performed by the system, for example, depending on a parameter input by a system administrator. In some embodiments, the technique of FIG. 10 may be performed at any suitable point in the process. For example, the optimization may be performed as part of initial graph construction of block 204 of FIG. 2.

In some embodiments, the optimization may be performed as an additional step to enhance the performance of the graph discriminator on low confidence adversarial examples. In particular, if the probabilities of the graph being benign is below a pre-defined threshold Th₁, and the probability of the graph being adversarial is also below a pre-defined threshold Th₂, the system may utilize this technique to generate a new graph for the queried sample and feed it back to the discriminator. In some embodiments, a goal of the optimization process is to maximize the probability of connecting a benign sample to other benign samples, and vice versa. In some embodiments, this optimization process may be used as a primary (e.g., sole) process used to perform node retrieval for selecting nodes of the graph.

Turning to FIG. 10 in further detail, a process for optimizing selection of anode for inclusion into the LNG is depicted. In some embodiments, for a given node (E) of a current graph 1002 (e.g., which may include only the center (e.g., initial) node (as shown in FIG. 10) and/or other nodes that have already been included from the reference dataset), the system may first find the nearest neighbors of the node E from both benign images (N_{ben}) and adversarial images (N_{adv}). For example, the system may select a first candidate nearest neighbor 1004 for a particular node of the current graph 1002. The first candidate nearest neighbor 1004 may be selected from a first subset of objects having a first classification (e.g., benign). The first candidate nearest neighbor 1004 may further be associated with a first candidate feature vector of feature vectors obtained from the reference dataset. The system may also select a second candidate nearest neighbor 1006 for the particular node of the current graph 1002. The second candidate nearest neighbor 1006 may be selected from a second subset of objects having a second classification (e.g., adversarial). The second candidate nearest neighbor 1006 may further be associated with a second candidate feature vector of feature vectors obtained from the reference dataset. The system may then input the current adjacency matrix (for the LNG) and current nodes features representation (e.g., the current embedding matrix), and the nearest benign N_{ben} and adversarial N_{adv} neighbors encodings to a graph neural network-based node selector 1008. The node selector 1008 may connect one of the benign and adversarial nodes (e.g., from the candidate nearest neighbors 1004 and 1006) to the graph according to the model decision. This process may be repeated until the graph is fully constructed (e.g., based on k and l).

To train the node selector 1008, the system may generate a new graph-based dataset. For example, at each step, the system may generate two graphs by connecting the current graph to a benign or adversarial sample, and then, the system may update the current graph according to its original label. For example, if the sample was labeled as benign, the system may update the current graph as the graph connected to the new benign sample. The label at each step may represent which node the system has connected to the current graph. For instance, if the system has updated the current graph by connecting the new benign node, the label of that step will be “0,” indicating that the benign node was selected. Similarly, if the current graph were updated by connecting the new adversarial node, the label of that step is set to “1.” Note that each step may have a single label, and it may include the current graph at that step, and the benign and adversarial samples encodings. For a graph with 21 nodes, this process may generate 40 ((|G|−1)×2) different instances to train the node selector.

3. Edge Estimation

Once the nodes of the LNG are selected (e.g., for example, determined as k-NNG and/or the optimization process described herein), the system may determine the edges of the LNG. The edges may correspond to paths to control the information aggregation across the graph, which creates the context to determine the center node's class. In some embodiments, since each node's embedding is extracted independently, the system may automatically determine the context used for adversarial detection. The system may also determine the pair-wise relation between the query example and its neighbors. Accordingly, in some embodiments, the system may connect nodes in the generated graph with the center node (e.g., using direct linking) and adopt a data-driven approach to re-estimate the connections between neighbors. To facilitate the data-driven approach, an edge estimation function may model the relation between two nodes i, j. In one example, the edge estimation function may correspond to a sigmoid function of the Euclidean distance between them:

$${A}_{i , j} = \frac{1}{1 + exp ( - t \cdot d ( i , j )} + θ$$

where d(i, j) is the Euclidean distance between i and j, and t, θ are two constant coefficients. In some embodiments, instead of manually assigning the coefficients t and θ, they may be learnable parameters and the system may optimize them in an end-to-end manner with the graph discriminator. In some embodiments, the edge estimation function may thus map the distance between node pairs from a first space (e.g., associated with the distance between the nodes) to a second space (e.g., based on applying the function). In some embodiments, any suitable function may be used to determine A_{i,j} (e.g., an edge weight) for a pair of nodes. For example, the function may use a non-linear or linear transformation. In some embodiments, the function may use multiple parameters, any of which may be optimized during a training process. In some embodiments, the edge weight may increase (e.g., monotonically) as the distance between two nodes decreases. In some embodiments, the function may thus be optimized for adversarial example detection using an LNG. For example, highly related nodes may be more closely connected to the center node, as indicated by a corresponding edge weight.

In some embodiments, the entries in A derived from the sigmoid function are real numbers in [0, 1]. In some embodiments, the system may further quantize the entries with a threshold value tₕ as follows:

$${A}_{i , j}^{′} = \{ \begin{matrix}0 , & if {A}_{i , j} < {t}_{h} \\ 1 , & if {A}_{i , j} \geq {t}_{h}\end{matrix}$$

The resulted binary A′ may be the final adjacency matrix of the LNG. Since the sigmoid function may be monotonic w.r.t. d(i, j), the threshold tₕ may also correspond to a distance threshold dₕ. A′ may imply that an edge exists between pairs of nodes closer than dₕ. In some embodiments, the system may perform a line search tₕ to choose the best value in validation.

C. Training a Graph Discriminator

Techniques herein involve using a graph discriminator to detect (e.g., classify/differentiate) whether a given sample is benign or adversarial. In some embodiments, the graph discriminator may be trained based on latent neighborhood graphs generated from from objects of a reference dataset. For example, for a given training iteration to train the graph discriminator, a particular LNG may be generated for a particular (e.g., different) object of a reference dataset, the particular object corresponding to a center node of the particular LNG. It should be understood that LNG graph data obtained from respective objects of any suitable reference dataset may be used to train the graph discriminator (e.g., over multiple training iterations). In some embodiments, any suitable graph data associated with each LNG (e.g., an adjacency matrix, an embedding matrix, and/or aggregation data derived from the matrices) may be used as training for the graph discriminator.

FIG. 11 illustrates a training process for a graph discriminator that may be used to perform adversarial sample detection, according to some embodiments. In some embodiments, the graph discriminator may use a specific graph attention network architecture 1108 to aggregate information from z (e.g., a center node) and its neighbors, and at the same time learn the optimal t and 0 (e.g., edge estimation parameters) to create the right context from z's neighbors for adversarial detection. The network 1108 may take two inputs obtained from a given LNG 1102: an embedding matrix X 1106 and the adjacency matrix A 1104 of the latent neighborhood graph, described herein (see block 716 of FIG. 7). In some embodiments, the graph attention network architecture 1108 may include multiple consecutive graph attention layers (e.g., three layers, four layers), followed by a dense layer with 512 neurons, and a dense classification layer with two-class output. Formally, let f denote a function in the model class, and let X_{z} and A_{z} denote the embedding and adjacency matrix of an input z generated by the LNG algorithm. During the training stage, the system may solve:

$${f}^{*} = \begin{matrix}arg min \\ f\end{matrix} {\sum }_{( z , y )} l ( f ( {A}_{z} , {X}_{z} ) , y )$$

where f is the cross-entropy loss between the class probability prediction and the true label. Accordingly, the method may characterize the local manifold with LNG, and may adapt to different local manifolds based on the graph attention network. It should be understood that any suitable machine learning model may be trained to minimize a loss between the class prediction of the graph discriminator and a ground truth label (e.g., corresponding to the actual classification of the training sample).

### IV. Methods

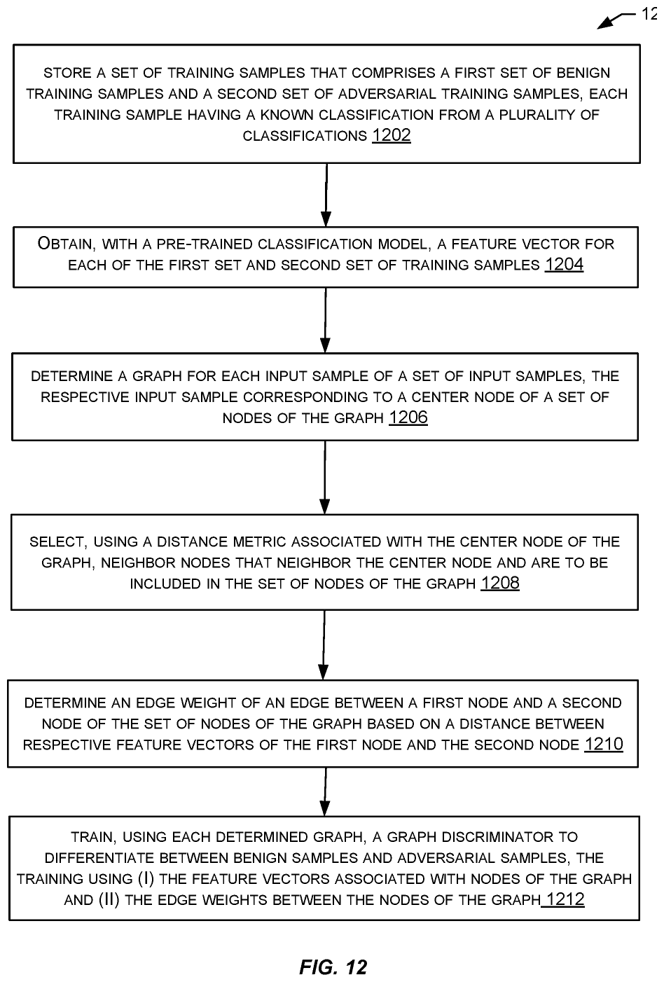

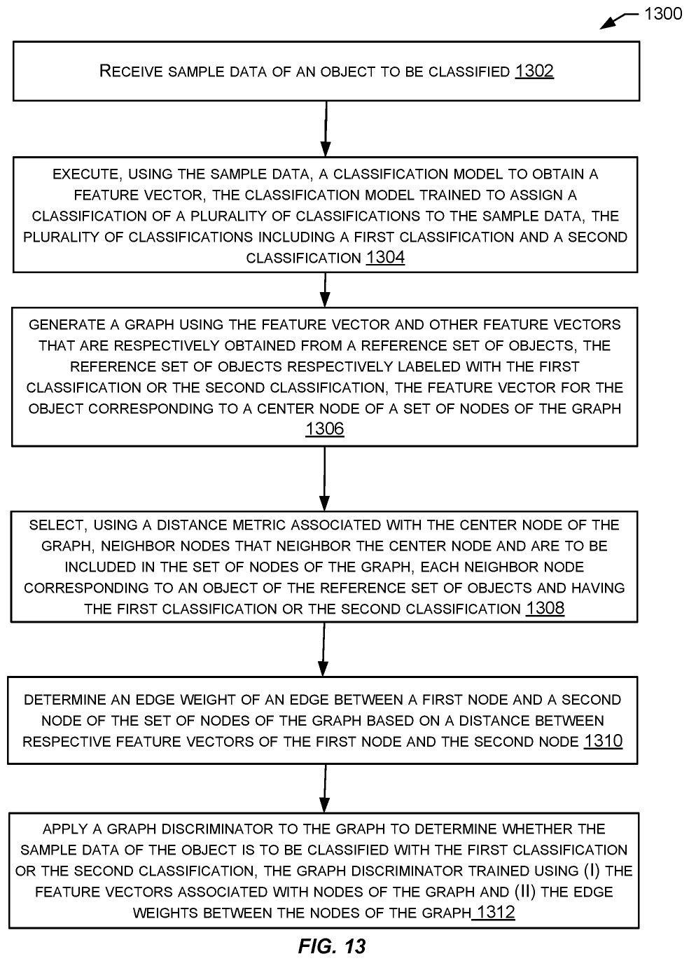

FIGS. 12 and 13, respectively show flowcharts for training (e.g., process 1200 of FIG. 12), and then using (e.g., process 1300 of FIG. 13), a machine learning model (e.g., a graph discriminator) to differentiate between a first classification (e.g., a benign sample) and a second classification (e.g., an adversarial sample). In some embodiments, process 1200 and/or 1300 may be performed by any one or more of the systems and/or system components described herein (e.g., see FIGS. 1 and/or 2).

A. Training a Machine Learning Model to Differentiate Between Benign and Adversarial Samples

As described above, process 1200 of FIG. 12 depicts a flow for training a machine learning model to differentiate between benign and adversarial samples.

At block 1202 of process 1200, a system may store a set of training samples that comprises a first set of benign training samples and a second set of adversarial training samples. In some embodiments, each training sample may have a known classification from a plurality of classifications. In some embodiments, the set of training samples stored may be obtained from any suitable dataset (e.g., CIFAR-10, ImageNet, and/or STL-10) and/or subset thereof (e.g., a reference dataset, as described herein). In some embodiments, a sample may correspond to any suitable data object(s) (e.g., an image, a video clip, a text file, etc.). In some embodiments, the second set of adversarial training examples may be generated using any suitable one or more adversarial sample generation methods (e.g., FGSM, C&W L2, etc.), as described herein.

At block 1204, the system may obtain, with a pre-trained classification model, a feature vector for each training sample of the first set and the second set of training samples. In some embodiments, one or more operations of block 1204 may be similar to as described in reference to FIG. 4.

At block 1206, the system may determine a graph (e.g., a latent neighborhood graph (LNG) for each input sample of a set of input samples. In some embodiments, the respective input sample may correspond to a center node of a set of nodes of the graph. In some embodiments, the process of determining a graph may include one or more operations, as described below in reference to block 1208 and block 1210. In some embodiments, one or more operations of block 1206 may be similar to as described in reference to FIG. 7-10. In some embodiments, the set of input samples may be obtained from any suitable dataset (e.g., a subset of the CIFAR-10 dataset, the ImageNet dataset, and/or the STL-10 dataset), which may (or may not) be different from the set of training samples.

At block 1208, the system may select, using a distance metric associated with the center node of the graph, neighbor nodes that neighbor the center node and are to be included in the set of nodes of the graph. In some embodiments, each neighbor node may be labeled as either a benign training sample or an adversarial training sample of the set of training samples. In some embodiments, the distance metric may be associated with parameters for a k-nearest neighbors algorithm. In some embodiments, feature vectors for the set of nodes of the graph may be represented by an embedding matrix. In some embodiments, the node selection process and/or distance metric may utilize an optimization (e.g., fine-tuning) process, for example, that utilizes a trained neural network to select nodes for inclusion with the graph (e.g., see FIG. 10).

At block 1210, the system may determine an edge weight of an edge between a first node and a second node of the set of nodes of the graph based on a distance (e.g., a Euclidean distance) between respective feature vectors of the first node and the second node. In some embodiments, an edge weight may be determined via an edge estimation function, as described herein. In some embodiments, the edge weights of the graph may be stored within an adjacency matrix. In some embodiments, the adjacency matrix may be updated (e.g., based on a threshold value) to reflect a binary determination of whether an edge between two nodes of the graph exist or not.

At block 1212, the system may train, using each determined graph, a graph discriminator to differentiate between benign samples and adversarial samples. In some embodiments, the training may involve using (I) the feature vectors associated with nodes of the graph and (II) the edge weights between the nodes of the graph. In some embodiments, one or more operations of block 1212 may be similar to as described in reference to FIG. 11. In some embodiments, a new sample object may be added to the reference set based on a classification by a trained graph discriminator, as described herein. For example, an object may be labeled using the classification by the graph discriminator and used to update the reference set of objects for subsequent use in generating an LNG.

B. Using a Machine Learning Model to Differentiate Between Benign and Adversarial Samples

As described above, process 1300 of FIG. 13 depicts a flow for a system using a trained machine learning model (e.g., trained via process 1200) to differentiate between benign and adversarial samples.

At block 1302 of process 1300 of FIG. 12, a system may receive sample data of an object to be classified. In some embodiments, one or more operations of block 1302 may be similar to as described in reference to block 702 of FIG. 7.

At block 1304, the system may execute a classification model to obtain a feature vector. In some embodiments, the classification model may be trained to assign a classification of a plurality of classifications to the sample data, the plurality of classifications including a first classification (e.g., benign) and a second classification (e.g., adversarial). It should be understood that any suitable classification types may be suitable to perform embodiments described herein (e.g., low risk, high risk, etc.). In some embodiments, one or more operations of block 1304 may be similar to as described in reference to block 704 of FIG. 7.

At block 1306, the system may generate a graph using the feature vector and other feature vectors that are respectively obtained from a reference set of objects. In some embodiments, the reference set of objects may be respectively labeled with the first classification or the second classification. The feature vector for the object may correspond to a center node of a set of nodes of the graph. In some embodiments, the process of determining a graph may include one or more operations, as described below in reference to block 1308 and block 1310 (see also FIGS. 7-10). In some embodiments, the reference set of objects may be obtained from any suitable dataset (e.g., CIFAR-10, ImageNet, and/or STL-10) and/or subset thereof (e.g., a reference dataset, as described herein). In some embodiments, the reference set of objects may be similar (e.g., the same) or different (e.g., updated) from that used to train the graph discriminator in process 1200.

At block 1308, the system may select, using a distance metric associated with the center node of the graph, neighbor nodes that neighbor the center node and are to be included in the set of nodes of the graph, each neighbor node corresponding to an object of the reference set of objects and having the first classification or the second classification. In some embodiments, one or more operations of block 1308 may be similar to as described in reference to block 1208 of process 1200.

At block 1310, the system may determine an edge weight of an edge between a first node and a second node of the set of nodes of the graph based on a distance between respective feature vectors of the first node and the second node. In some embodiments, one or more operations of block 1310 may be similar to as described in reference to block 1210 of process 1200.

At block 1312, the system may apply a graph discriminator to the graph to determine whether the sample data of the object is to be classified with the first classification or the second classification. In some embodiments, the graph discriminator may be trained using (I) the feature vectors associated with nodes of the graph and (II) the edge weights between the nodes of the graph. In some embodiments, one or more operations of block 1312 may be similar to as described in reference to block 718 of FIG. 7. In some embodiments, the reference set may be updated to include new objects, for example, determined to have been generated via anew adversarial attack method. In some embodiments, the graph discriminator may not necessitate retraining even when new objects are added to update the reference set operable for generating an LNG.

### V. Experiments

The adversarial example detection approach described herein has been evaluated against at least six state-of-the-art adversarial sample generation methods: FGSM (L-infinity (L∞)), PGD (Lo), CW (L∞), AutoAttack (L∞), Square (L∞), and boundary attack. The attacks were implemented on three datasets: CIFAR-10, ImageNet dataset, and STL-10. The performance is compared to four state-of-the-art adversarial examples detection approaches, namely Deep k-Nearest Neighbors (DkNN) [N. Papernot and P. D. McDaniel, Deep k-nearest neighbors: Towards confident, interpretable and robust deep learning; CoRR, abs/1803.04765, 2018], kNN [A. Dubey et al., Defense against adversarial images using web-scale nearest-neighbor search. In IEEE Conference on Computer Vision and Pattern Recognition, CVPR, 2019], LID [X. Ma et al., Characterizing adversarial subspaces using local intrinsic dimensionality; In 6th International Conference on Learning Representations, ICLR. OpenReview.net, 2018], as well as Hu et al. [S. Hu et al., A new defense against adversarial images: Turning a weakness into a strength; In Advances in Neural Information Processing Systems 32: Annual Conference on Neural Information Processing Systems, NeurIPS, pages 1633-1644, 2019].

A. Threat Model

The method described herein is evaluated in both the white-box and gray-box settings. In the following, a brief description of each setting is provided below.

White-box Setting: In this setting, the adversary may be aware of the different steps involved in the adversarial defense method but does not have access to the method's parameters. Additionally, in this example, it is assumed that datasets used for training the baseline classifier and the graph discriminator are available to the adversary. To implement the white-box attack, the attack strategy of Carlini and Wagner (CW) is used. The objective function of the CW minimization is modified as follows:

$$\begin{matrix}arg min \\ {I}_{adv}\end{matrix} {‖ {I}_{adv} - I ‖}_{2}^{2} + c \cdot ( {l}_{CW} ( {l}_{adv} ) + {l}_{d} ( D ( {l}_{adv} ) ) ) ,$$

where l_{CW} is the original adversarial loss term used in CW, and D(I_{adv}) is negative of the summation of the distances between the adversarial example and each adversarial example in the constructed nearest neighbor graph, defined as:

$${l}_{d} ( D ( {I}_{adv} ) ) := - \sum {D}_{adv} = {{\sum }^{N}}_{i = 1} \begin{matrix}0 ; x ( {v}_{i} ) ∈ {X}_{D} \\ ‖ {x}_{adv} - x ( {v}_{i} ) ‖ ; x ( {v}_{i} ) ∈ x {D}_{p}\end{matrix}$$

where vᵢ is a node in a constructed graph. X_{D} and X_{D}_{_{P}} are the embeddings of the reference dataset and their corresponding adversarial examples, respectively. The newly generated adversarial example I_{adv} is pushed to be far away from the adversarial examples of the generated graph at each iteration. The intuition is that, ideally, a graph consisting only of benign examples is more likely to be classified as benign, and this necessitates moving the white-box adversary towards the decision boundaries of an adversary class, while moving away from the possible nearby adversarial examples. This process may necessitate regenerating the graph of adv in each iteration of the attack, since the applied perturbation affects the embedding space. This attack may be referred to as CW_{wb}.

Gray-box Setting. In this setting, the adversary is unaware of the deployed adversarial defense, but knows the pre-trained classifier's parameters. For the decision boundary attack, however, only an oracle to query the classifier for the prediction output is provided to the adversary. Unless stated otherwise, the threat model may be assumed to be gray-box (i.e. unaware of the implemented defense).

B. Comparison with State-of-the-Art

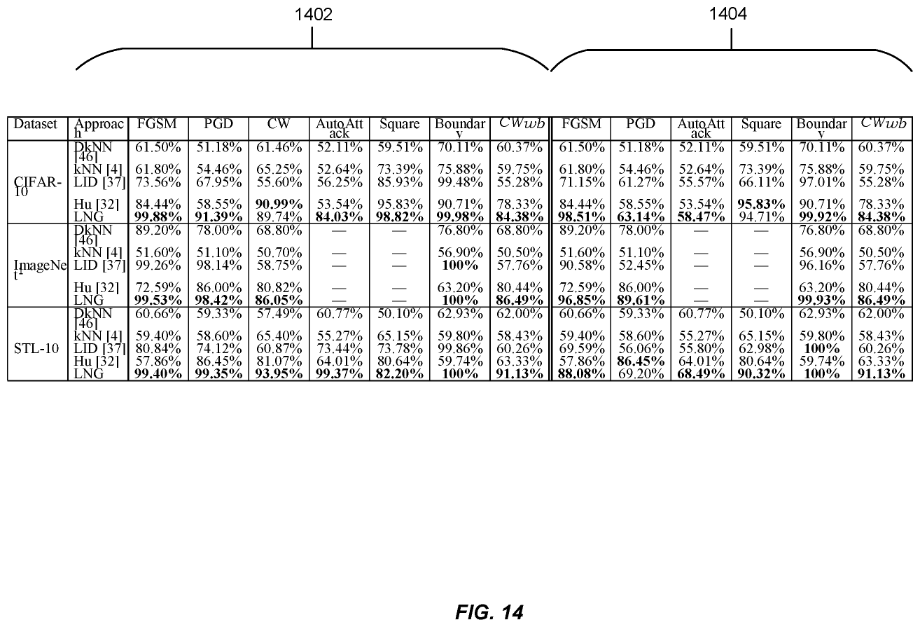

FIG. 14 depicts a table that compares the performance of the proposed method on detecting adversarial examples with state-of-the-art attacks. In the table of FIG. 14., the (AUC) of different adversarial detection approaches is shown. On the left side 1402 of the table, the performance of different adversarial detection approaches is shown. LID and the method described herein are trained on the same attack evaluated on. On the right side 1404, the LID and the method described herein are trained on CW adversarial examples, and tested on different unseen attacks.

Detecting known attacks: Turning to the left side 1402 of the table in further detail, this side compares the performance of the method herein on detecting adversarial examples generated using known attacks with the four state of-the-art adversarial example detection approaches described herein: DkNN, kNN, LID, and Hu, et. al, on three datasets, CIFAR-10, ImageNet, and STL-10. The results are reported using an area under the ROC curve metric (AUC). The LID and the proposed detection method are trained and tested using the same adversarial attack methods, except for CW_{wb} attack, where the detector is trained on the traditional CW attack. The table of FIG. 14 reports the performance of the graph discriminator trained using the Latent Neighborhood Graph (LNG) and the k-Nearest-Neighbor Graph (k-NNG). Experimental results demonstrate that the proposed approach outperforms state-of-the-art adversarial example detection methods on both datasets. The performance benefit is especially significant in the detection of white-box (CW_{wb}) attack, where adversarial and benign space are deeply interleaved with each other. This is true in part because the method generates a highly discriminative neighborhood graph based on the input example's local manifold structure, and hence it is able to distinguish between adversarial and benign examples with high accuracy. Similar performance benefit is observed in case of FGSM and Autoattacks on STL-10 dataset.

Detecting unseen attacks: In this experiment, the robustness of the method described herein is compared against unseen adversarial attacks to state-of-the-art adversarial detection methods. Each adversarial example detection method is trained using CW attack, and evaluated on other attacks. The results are shown on the right side 1404 of the table in FIG. 14. The proposed approach outperforms other methods by a significant margin on different attack configurations.

C. Ablation Study

The objective of this experiment is to compare the performance of k-NNG and LNG with and without using adversarial examples from the reference dataset. The results are shown in Table 1 (below) for CIFAR-10 and ImageNet. The edge estimation process used to construct the LNG improves the overall performance of the proposed detection method. Significant performance improvement is also observed when using reference adversarial examples as it results in better estimation of the neighborhood of the input image. The reported improvement due to the use of adversarial examples (over 20% in some cases) is especially beneficial in detecting stronger attacks (PGD, and CW).

TABLE 1
The (AUC) performance (%) of the approach disclosed herein using
clean vs. adversarially augmented (Adv.) reference sets.

| | | | | | | Bound- | |
|---|---|---|---|---|---|---|---|
| Dataset | Approach | Adv. | FGSM | PGD | CW | ary | CW_{wb} |
| CIFAR- | k-NNG | x | 97.38 | 54.29 | 86.45 | 99.92 | 74.84 |
| 10 | | ✓ | 99.54 | 85.78 | 89.63 | 99.89 | 81.44 |
| | LNG | x | 99.24 | 85.62 | 89.91 | 99.96 | 80.77 |
| | | ✓ | 99.88 | 91.39 | 89.74 | 99.98 | 84.38 |
| ImageNet | k-NNG | x | 97.25 | 90.78 | 50.49 | 99.91 | 51.56 |
| | | ✓ | 99.58 | 98.36 | 79.03 | 100 | 77.01 |
| | LNG | x | 99.40 | 94.98 | 81.24 | 99.99 | 81.64 |
| | | ✓ | 99.53 | 98.42 | 86.05 | 100 | 86.49 |

D. Impact of Graph Topology

The objective of this experiment is to investigate the impact of graph topology on detection performance. The following graph types are compared: i) a k-nearest neighbor graph, as described herein (k-NNG), ii) graph with no connections between nodes (NC), iii) graph with connections between all nodes (AC), iv) the k-NNG where the center node is connected to all nodes in the neighborhood (CC), and v) the proposed latent neighborhood graph (LNG) where the input node is connected to all nodes with estimated edges between the neighborhood nodes. Table 2 presents the performance of the detector trained on each graph for CIFAR-10, and ImageNet datasets, where the discriminator is trained and evaluated on the same attack configuration. Overall, connecting the center node with neighbor nodes helped aggregate the neighborhood information towards the input example, which improves the performance. By connecting the neighborhood nodes adaptively, LNG provides better context for the graph discriminator.

TABLE 5
The (AUC) performance (%) of using different connections
configurations in the neighborhood graph.

| Dataset | Approach | FGSM | PGD | CW | Boundary | CW_{wb} |
|---|---|---|---|---|---|---|
| CIFAR-10 | k-NNG | 99.54 | 85.78 | 89.63 | 99.89 | 81.44 |
| | NC | 99.72 | 87.21 | 87.53 | 99.81 | 81.60 |
| | AC | 99.83 | 87.72 | 90.67 | 99.83 | 80.43 |
| | CC | 99.72 | 88.67 | 91.51 | 99.94 | 82.92 |
| | LNG | 99.88 | 91.39 | 89.74 | 99.98 | 84.38 |
| ImageNet | k-NNG | 99.58 | 98.36 | 79.03 | 100 | 77.01 |
| | NC | 99.70 | 98.51 | 77.42 | 100 | 74.99 |
| | AC | 99.66 | 98.35 | 79.74 | 100 | 78.15 |
| | CC | 99.66 | 98.23 | 78.19 | 100 | 75.59 |
| | LNG | 99.53 | 98.42 | 86.05 | 100 | 86.49 |

NC: no connections between nodes, AC: all connected graph, CC: only the center node is connected to all nodes.

E. Graph Detection: Time Comparison

For LNG method, on average, the detection process of each image may take 1.55 and 1.53 seconds for CIFAR-10 and ImageNet datasets, respectively. The time includes (i) embedding extraction, (ii) neighborhood retrieval, (iii) LNG construction, and (iv) graph detection. This is significantly lower in comparison to Hu et al., which requires an average of 14.05 and 5.66 seconds to extract the combined characteristics from CIFAR-10 and ImageNet dataset, respectively.

Accordingly, as described herein, detection of adversarial examples, particularly generated using unseen adversarial attacks, is a challenging security problem for deployed deep neural network classifiers. In some embodiments, a graph-based adversarial example detection method is disclosed that generates latent neighborhood graphs in the embedding space of a pre-trained classifier to detect adversarial examples. The method achieves state-of-the-art adversarial example detection performance against various white-and gray-box adversarial attacks on three benchmark datasets. Also, the effectiveness of the approach on unseen attacks is described, where training via the disclosed method and using a strong adversarial attack (e.g., CW) enables robust detection of adversarial examples generated using other attacks.

In some embodiments, training on a stronger attack enables the detection of unknown weaker attacks. In some embodiments, the graph discriminator may output higher accuracy even when low perturbation is applied. Graph topology and subgraphs may be used by the graph neural networks to output the decision (e.g., deciding whether the image is benign or adversarial). As described herein, the embodiments described herein have a flexible design with multiple parameters that may be fine-tuned.

### VI. Computer System

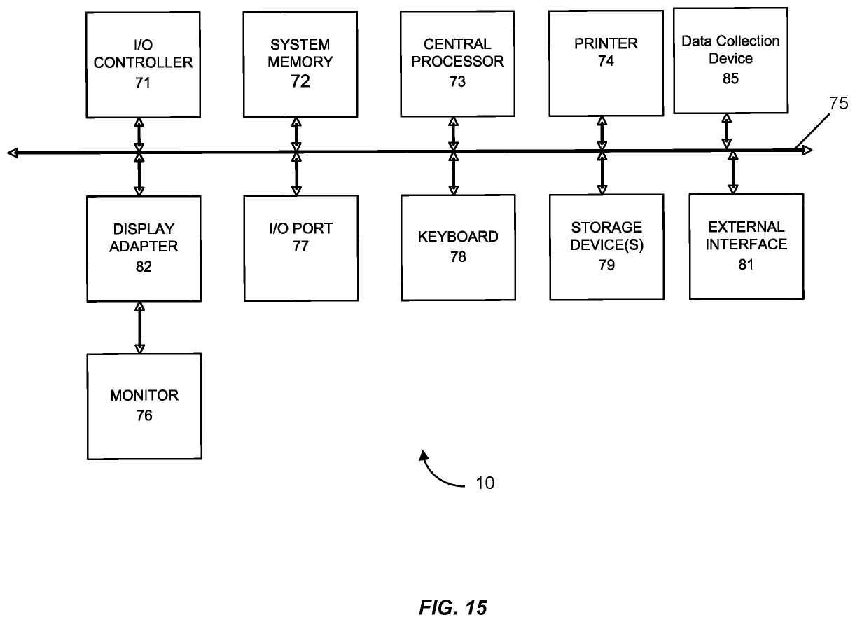

Any of the computer systems mentioned herein may utilize any suitable number of subsystems. Examples of such subsystems are shown in FIG. 15 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 15 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such storage or transmission devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

1. A method for classifying an input sample as adversarial or benign, the method comprising:
storing a set of training samples that comprises a first set of benign training samples and a second set of adversarial training samples, each training sample having a known classification from a plurality of classifications, the second set of adversarial training samples being generated using an adversarial sample generation method;
obtaining, with a pre-trained classification model, a feature vector for each training sample of the first set and the second set;
determining a graph for each input sample of a set of input samples, a respective input sample corresponding to a center node of a set of nodes of the graph, wherein determining the graph comprises:
selecting, using a distance metric associated with the center node of the graph, neighbor nodes that neighbor the center node and are to be included in the set of nodes of the graph, each neighbor node labeled as either a benign training sample or an adversarial training sample of the set of training samples; and
determining an edge weight of an edge between a first node and a second node of the set of nodes of the graph based on a distance between respective feature vectors of the first node and the second node; and
training, using each determined graph, a graph discriminator to differentiate between benign samples and adversarial samples, the training using (I) the feature vectors associated with nodes of the graph and (II) the edge weights between the nodes of the graph.

2. The method of claim 1, wherein the graph comprises an embedding matrix and an adjacency matrix, wherein the embedding matrix comprises a plurality of feature vectors for the set of nodes of the graph, a feature vector corresponding to an embedding of the embedding matrix, and wherein the adjacency matrix comprises edge weights for edges that connect the nodes of the graph.

3. The method of claim 1, wherein selecting the neighbor nodes for inclusion within the graph comprises generating a k-nearest neighbor graph that determines the neighbor nodes as being nearest neighbors from the center node, the distance metric being associated with parameters for generating the k-nearest neighbor graph.

4. The method of claim 1, wherein the edge weight between the first node and the second node of the graph is inversely correlated with the distance between the respective feature vectors of the first node and the second node.

5. The method of claim 1, wherein the edge weight is determined based on a function that maps the distance between the respective feature vectors of the first node and the second node from a first space to a second space.

6. The method of claim 5, wherein the training the graph discriminator further comprises:
determining parameters for the function, the parameters determined using each of the input samples.

7. The method of claim 1, wherein a particular input sample of the input samples is associated with a ground truth label, and wherein the graph discriminator comprises a neural network that outputs a class prediction of whether the particular input sample is benign or adversarial, and wherein the neural network is trained by minimizing a loss between the class prediction of the graph discriminator and the ground truth label.

8. The method of claim 7, wherein the graph discriminator receives as input, for a given training iteration, an adjacency matrix and an embedding matrix that are associated with the particular input sample.

9. A method of using a machine learning model, the method comprising:
receiving sample data of an object to be classified;
executing, using the sample data, a classification model to obtain a feature vector, the classification model trained to assign a classification of a plurality of classifications to the sample data, the plurality of classifications including a first classification and a second classification;
generating a graph using the feature vector and other feature vectors that are respectively obtained from a reference set of objects, the reference set of objects respectively labeled with the first classification or the second classification, the feature vector for the object corresponding to a center node of a set of nodes of the graph, wherein determining the graph comprises:
selecting, using a distance metric associated with the center node of the graph, neighbor nodes that neighbor the center node and are to be included in the set of nodes of the graph, each neighbor node corresponding to an object of the reference set of objects and having the first classification or the second classification; and
determining an edge weight of an edge between a first node and a second node of the set of nodes of the graph based on a distance between respective feature vectors of the first node and the second node; and
applying a graph discriminator to the graph to determine whether the sample data of the object is to be classified with the first classification or the second classification, the graph discriminator trained using (I) the feature vectors associated with nodes of the graph and (II) the edge weights between the nodes of the graph.

10. The method of claim 9, wherein the reference set of objects comprises a first subset of objects respectively labeled with the first classification and a second subset of objects respectively labeled with the second classification.

11. The method of claim 10, wherein generating the graph further comprises:
selecting a first candidate nearest neighbor for a particular node of a current graph, the first candidate nearest neighbor selected from the first subset of objects having the first classification and associated with a first candidate feature vector of the feature vectors obtained from the reference set of objects;
selecting a second candidate nearest neighbor for the particular node of the current graph, the second candidate nearest neighbor selected from the second subset of objects having the second classification and associated with a second candidate feature vector of the feature vectors obtained from the reference set of objects;
inputting (I) a current adjacency matrix of the current graph, (II) a current embedding matrix of the current graph, (III) the first candidate feature vector, and (IV) the second candidate feature vector into a neural network, the neural network trained to select one of the candidates; and
connecting a candidate selected by the neural network to the particular node of the current graph.

12. The method of claim 9, wherein selecting the neighbor nodes comprises determining nearest neighbors from the center node of the graph, the distance metric associated with parameters for determining the nearest neighbors.

13. The method of claim 9, wherein the graph comprises an embedding matrix and an adjacency matrix, wherein the embedding matrix comprises a plurality of feature vectors for the set of nodes of the graph, and wherein the adjacency matrix comprises edge weights for edges that connect the nodes of the graph.

14. The method of claim 9, wherein the first classification corresponds to a benign object and the second classification corresponds to an adversarial object.

15. The method of claim 14, wherein the adversarial object is generated by perturbing the benign object using entropy data.

16. The method of claim 9, wherein object corresponds to an adversarial object, wherein the classification model initially assigns the classification of the object as being a benign object, and wherein the graph discriminator uses the feature vector obtained from the classification model to determine that the object is adversarial.

17. The method of claim 9, wherein the object comprises a credential of a user, the credential operable for validating whether the user has authorization to access a resource.

18. The method of claim 9, wherein the graph discriminator comprises a neural network that is trained to aggregate the feature vector with the other feature vectors of the graph, the aggregation performed using the edge weights between nodes of the graph.

19. The method of claim 9, wherein generating the graph comprises performing a fine-tuning process that selects nodes for inclusion into the graph using a neural network, wherein the neural network is trained to select, for each iteration, a candidate nearest neighbor from either a first subset of the reference set of objects or a second subset of the reference set of objects, the first subset associated with the first classification and the second subset associated with the second classification.

20. The method of claim 9, further comprising:
labeling the object using the classification determined by the graph discriminator; and
updating the reference set of objects to include a new reference object that corresponds to the labeled object.

21-22. (canceled)
